(19) United States
(12) Patent Application Publication
(10) Pub. No.: US 2015/0077551 A1
(43) Pub. Date: Mar. 19, 2015

(54) TRAIL CAMERA

(71) Applicant: Bushnell, Inc., Overland Park, KS (US)

(72) Inventors: Kristin Simeroth, Leawood, KS (US); Darin Stephens, Independence, MO (US); Wei Cao, Overland Park, KS (US); Nick Wolfe, Olathe, KS (US)

(73) Assignee: Bushnell, Inc., Overland Park, KS (US)

(21) Appl. No.: 14/030,786

(22) Filed: Sep. 18, 2013

(51) Int. Cl. H04N 1/00; G06Q 30/06; H04N 17/00

(52) U.S. Cl. CPC H04N 1/00214; H04N 17/002; H04N 1/00281; G06Q 30/0623
USPC 348/143; 705/26.61

(57) ABSTRACT

A trail camera comprises a camera operable for capturing images; a communication device for transmitting the images to a remote server; and a controller for prompting the camera to automatically capture a test image a pre-determined number of seconds after the trail camera is set-up. A method of checking the communication coverage of the trail camera; comprises placing a scannable code on packaging or a display associated with the trail camera; instructing a customer to scan the scannable code with a mobile communication device before the customer purchases the trail camera; prompting the customer to enter information into the mobile communication device that specifies a geographic area where the trail camera will be used; and providing to the mobile communication device coverage information for the geographic area so the customer can determine if the trail camera will have communication coverage in the geographic area before the customer purchases the trail camera.

### BACKGROUND

The present invention relates to trail cameras and improved methods of operating and controlling the same.

Trail cameras are basically cameras with sensors that are operable to capture images upon sensing movement, heat, light, sound, or other activities that indicate the presence of an animal, human, or other object. Such cameras are typically housed in weatherproof enclosures and are often mounted to trees, fence posts, and other outdoor supports for capturing images of animals or mounted in homes or other buildings for capturing images of people.

Early versions of trail cameras stored images on resident memory only, thus requiring users to travel to the trail cameras to retrieve and view the images. Modern trail cameras include communication devices for wirelessly transmitting captured images to remote computers so users can more quickly and conveniently view the images. Unfortunately, many modern trail cameras are difficult and confusing to set-up and operate.

### SUMMARY

The present invention solves at least some of the above-described problems and provides a distinct advance in the art of trail cameras. More particularly, the present invention provides a trail camera with wireless communication capabilities that is simpler and more intuitive to set-up and operate and that includes features and functions not found in existing trail cameras.

Most prior art trail cameras with wireless communication capabilities require a wireless phone plan. Users first purchase the trail cameras and then establish wireless phone plans with their chosen carriers. Applicant has discovered that users are often dissatisfied with their purchase experiences because their chosen wireless phone carriers often don't have adequate wireless coverage in the areas in which they wish to use their trail cameras. Unfortunately, most consumers don't discover this fact until they have mounted their cameras to trees, fence posts, etc. This forces the users to either re-position their trail cameras in areas with better wireless coverage or to return them and cancel the associated wireless phone plans.

An embodiment of the present invention solves this problem by providing a trail camera with a pre-loaded wireless phone plan and a method of checking the communication coverage of the trail camera before it is purchased. An embodiment of the method may comprise placing a scannable code on packaging or a display associated with the trail camera; instructing a customer to scan the scannable code with a mobile phone or other communication device before purchasing the trail camera; prompting the customer to enter information into the mobile communication device that specifies an area where the trail camera will be used; and providing to the mobile communication device coverage information for the area in which the trail camera will be used so the customer can determine if the trail camera will have communication coverage before the customer purchases the trail camera.

Applicant has also discovered that some users have trouble determining when their trail cameras have been properly set up and are ready to capture and send images. An embodiment of the invention solves this problem by providing a trail camera with a controller that prompts the camera to automatically capture a test image a pre-determined number of seconds after the trail camera is first set-up and then prompts the camera's communication device to automatically send the test image to a remote server. The remote server may then send the test image to the user's mobile phone and/or email account so the user can quickly and easily verify the trail camera is working and was set-up properly. The trail camera may also display a countdown before the camera captures the test image so that the user may aim the trail camera at a desired object before the test image is captured.

Applicant has also discovered that some users prefer to set-up and control their trail cameras locally while other users desire to set-up and control their trail cameras remotely. Embodiments of the present invention allow both by providing a trail camera with two-way command and control functionality. Specifically, an embodiment of the invention is a camera system that comprises at least one trail camera and a remote server. The trail camera includes a camera and sensors for capturing images; a communication device for wirelessly transmitting the images; and a controller for locally controlling the camera and the communication device and for communicating with the remote server. The server includes a communication device for receiving the images from the trail camera and website hosting capabilities for hosting a website accessible by a mobile phone or computer operated by a user of the trail camera. The website is operable to maintain configuration information for the trail camera, receive instructions from the computer or mobile phone operated by the user for remotely changing the configuration information, and receive information from the trail camera for changing the configuration information in accordance with changes made at the trail camera. This two-way command and control functionality allows a user to locally set-up and control the trail camera from the trail camera's user interface or remotely set-up and control the trail camera from a remote computer. In both cases, the controller at the trail camera receives and stores instructions needed for setting up the camera and the website receives and stores configuration information needed for handling images transmitted from the camera.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is an elevational view of a trail camera constructed in accordance with embodiments of the present invention.

FIG. 2 is a block diagram depicting several major components of the trail camera of FIG. 1.

FIG. 3 is a schematic representation of computer and communications equipment that may be used to implement aspects of the present invention.

FIG. 4 is a schematic representation showing how a mobile phone may be used to verify the wireless communication coverage of a trail camera before it is purchased.

FIG. 5 is a depiction of a screen display that may be presented to a user while verifying the wireless communication coverage of a trail camera.

FIG. 6 is a depiction of another screen display that may be presented to a user while verifying the wireless communication coverage of a trail camera.

FIG. 7 is a depiction of a screen display that may be presented to a user while setting up an account for the trail camera.

FIG. 8 is a depiction of another screen display that may be presented to a user while setting up an account for the trail camera.

FIG. 9 is a depiction of another screen display that may be presented to a user while setting up an account for the trail camera.

FIG. 10 is a depiction of another screen display that may be presented to a user while setting up an account for the trail camera.

FIG. 11 is a schematic representation showing how a computer may be used to help setup the trail camera.

FIG. 12 is another schematic representation showing how the computer may be used to help setup the trail camera.

FIG. 13 is another schematic representation showing how the computer may be used to help setup the trail camera.

FIG. 14 is another schematic representation showing how the computer may be used to help setup the trail camera.

FIG. 15 is a schematic representation showing how a test image is captured by the trail camera.

FIG. 16 is another schematic representation showing how a test image is captured by the trail camera.

FIG. 17 shows a log-in screen for a user account.

FIG. 18 shows a page from the user account.

FIG. 19 shows an enlarged view of the test image shown on the user account.

FIG. 20 shows an enlarged view of a map showing where the trail camera is located.

FIG. 21 shows a camera settings page of the user account.

FIG. 22 is a schematic representation showing how the trail camera may be set-up in the field.

FIG. 23 is another schematic representation showing how the trail camera may be set-up in the field.

FIG. 24 is another schematic representation showing how the trail camera may be set-up in the field.

FIG. 25 is another schematic representation showing how the trail camera may be set-up in the field.

FIG. 26 is a schematic representation showing how a test image is captured by the trail camera.

FIG. 27 is another schematic representation showing how a test image is captured by the trail camera.

FIG. 28 shows a screen display that may be presented on a mobile phone.

FIG. 29 shows another screen display that may be presented on the mobile phone.

FIG. 30 shows another screen display that may be presented on the mobile phone.

FIG. 31 shows another screen display that may be presented on the mobile phone.

FIG. 32 shows another screen display that may be presented on the mobile phone.

FIG. 33 shows another screen display that may be presented on the mobile phone.

FIG. 34 shows a screen display that may be presented on the trail camera.

FIG. 35 is a schematic representation showing how setting for the trail camera are uploaded to remote devices.

FIG. 36 is a schematic representation showing the capturing of an image with the trail camera and the transmission of the image to remote devices.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

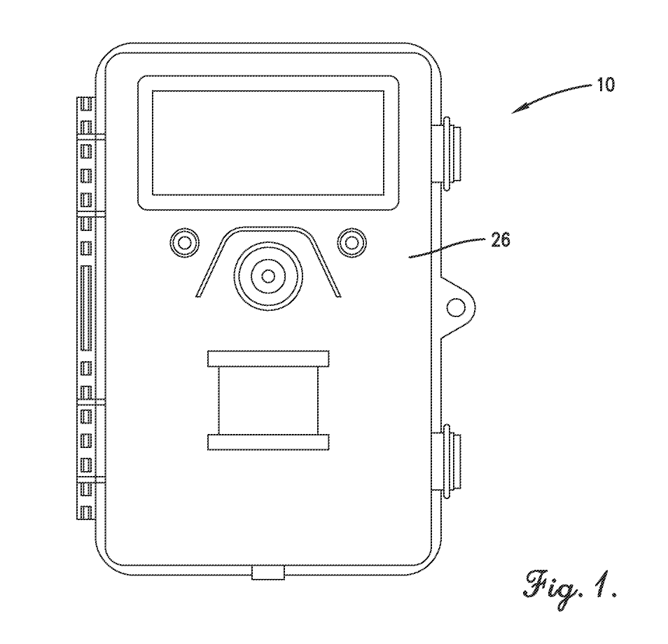

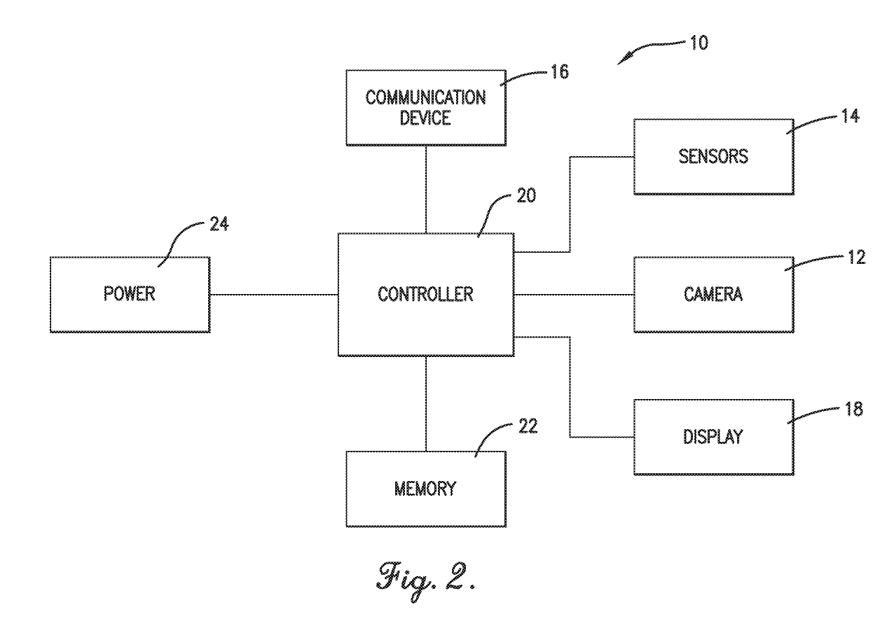

Turning now to the drawing figures, and initially FIGS. 1 and 2, a trail camera 10 constructed in accordance with various embodiments of the invention is depicted. The trail camera 10 may be mounted to a tree, post, building, wall, or anywhere else and is operable to capture images of animals, people, or any other objects that trigger its sensors as described below.

Embodiments of the trail camera 10 may comprise a camera 12, one or more sensors 14, a communications device 16, a display 18, a controller 20, memory 22, and a power source 24, all enclosed in a weatherproof enclosure 26. Some embodiments of the trail camera may also include a GPS receiver or other location determining devices. The trail camera 10 may also include other components, circuitry, and controls that are not relevant to the present invention and therefore not described in detail herein.

The camera 12 may employ any known image capturing technology. An embodiment of the camera may include a CCD/CMOS image sensor that is operable to capture and record still images or video images. The camera 12 may include various conventional camera elements such as a lens and a flash. The lens is conventional and can be adjusted to facilitate aiming and focusing of the camera. The flash may include any known flash elements such as conventional light emitting diodes (LED's), infrared LED's, Xenon strobes, and/or incandescent bulbs. The flash may enable night vision capabilities of the camera.

The sensors 14 are operable to detect the presence of an animal, person, or other object in the vicinity of the trail camera 10 and trigger the camera 12 to capture an image of the object. The sensors 14 may employ any technology operable to detect heat, light, motion, sound, vibration, the passage of time, etc., or any combination thereof to trigger the camera 12. For example, the sensors may include a passive infrared motion detector operable to detect movement of an animal or human or a heat detector operable to detect body heat from an animal or human.

The communications device 16 transmits images captured by the camera 12 to remote devices as described in detail below. The communications device 16 also transmits and receives data to and from remote devices as described below. In one embodiment, the communications device 16 is a wireless cellular radio transceiver operable to transmit and receive data via a wireless phone network such as those operated by AT&T, Sprint, and Verizon. The trail camera 10 is preferably pre-configured with a wireless plan from a wireless carrier to facilitate a method of confirming the communication coverage of the trail camera before it is purchased as described below.

The display 18 is operable to display messages, instructions, and other information and may employ any known display technology. In one embodiment, the display is a liquid crystal display (LCD). The display may incorporate touch screen technology and/or may be accompanied with conventional buttons, switches, and other user interface elements.

The controller 20 controls the camera 12 and the other components of the trail camera 10 and may comprise various computing elements, such as integrated circuits, microcontrollers, microprocessors, programmable logic devices, memory, etc, alone or in combination, to perform the operations described herein. The controller 20 may also include, or be coupled with, other components such as switches, sensors, etc. and may include circuitry or programs to determine when to capture and record an image with the camera 12 after triggering by the sensors 14.

The memory 22 stores images captured by the camera 12 and may also store programs, data, and other information for setting up and operating the trail camera 10. The memory 22 may comprise any non-transitory digital storage medium such as RAM, ROM, flash memory, a hard disk, magnetic or optical storage mediums, or other conventional digital mediums, and combinations thereof.

The power source 24 provides power to the other components of the trail camera 10 and may comprise any source of electricity such as batteries, a battery pack, or a receptacle for receiving power from an external source, such as a power line.

The optional GPS receiver or other location-determining device receives satellite signals from a global navigation satellite system and determines locations of the trail camera as a function of these signals. The controller may monitor the calculated locations and send an alert via the communications device 16 if the trail camera is moved from its installation location. The GPS receiver and controller 20 may also trigger the camera to capture one or more images if the trail camera is moved after it is installed in an attempt to capture images of the thief or other person moving the camera. These images may be transmitted from the trail camera via the communications device 16 in the same manner as other images as described below.

The above-described components and other components of the trail camera 10 may be housed in a weatherproof enclosure 26. The enclosure may include hinges, gaskets, seals, and other conventional features and may further include hangars, brackets, etc. for facilitating the attachment of the trail camera to trees, posts, walls, etc.

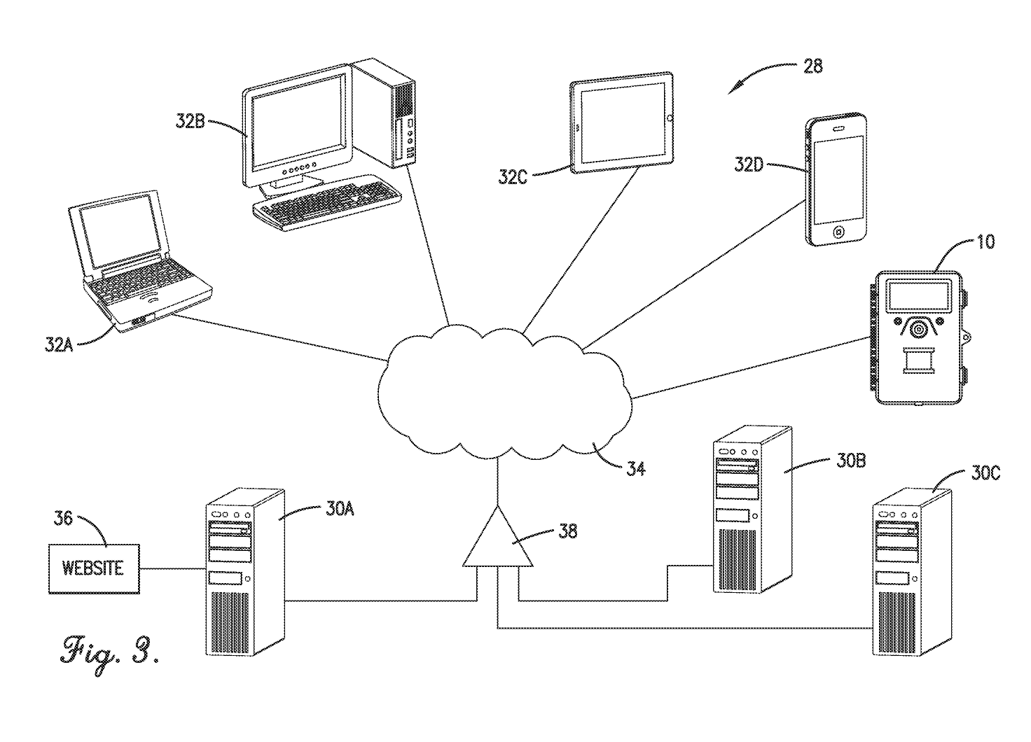

Aspects of the invention may be implemented in part by a camera system broadly referred to by the numeral 28 in FIG. 3 and a computer program or programs that are stored in and/or accessed by components of the camera system 28. The camera system 28 may include at least one trail camera 10, one or more host computers 30A-C, and any number of electronic devices 32A-D that may access the host computers 30A-C via a communications network 34. The computer programs and equipment illustrated and described herein are merely examples of programs and equipment that may be used to implement embodiments of the invention and may be replaced with other programs and computer equipment without departing from the scope of the invention.

The host computers 30A-C may serve as repositories for data and programs used to implement certain aspects of the present invention as described in more detail below. The host computers 30A-C may include any computing devices such as network or server computers and may be connected to a firewall to prevent tampering with information stored on or accessible by the computers. The functionality of the host computers may also be distributed amongst many different computers in a cloud computing environment.

One of the host computers 30A may operate or host a website 36 accessible by at least some of the devices 32A-D and/or the trail camera 10. The host computer 30A includes conventional web hosting operating software, an Internet connection such as a cable connection, satellite connection, DSL converter, or ISDN converter, and is assigned a URL and corresponding domain name such as “www.wirelesstrophycam.com”, “www.bushnell.com”, and/or “www.bushnell.mobi” so that the website hosted thereon can be accessed via the Internet in a conventional manner.

The host computers 30A-C may also host and support software and services of proprietary mobile application providers such as Google, Apple, and Blackberry. The camera system 28 may also include or use a data interchange format device 38 for distinguishing the types of devices 32A-D (e.g. mobile phone, desktop computer) that attempt to access the host computers 30A-C and for routing communications and requests to the host computers accordingly.

The electronic devices 32A-D may be operated by owners or users of the trial camera 10 or others wishing to receive or otherwise view images captured by the trail camera. The electronic devices 32A-D may include various types of devices that can access the host computers 30A-B via the communications network 34. The electronic devices 32A-D may include, for example, mobile communications devices such as wireless phones, tablet computers, laptop computers, personal computers, or network computers. Each electronic device 32A-D preferably includes or can access a web browser and a conventional Internet connection such as a wireless connection including a Wi-Fi connection or a 3G or 4G connection, a modem, DSL converter, or ISDN converter that permits it to access the Internet.

Although FIG. 3 depicts a particular number of electronic devices 32A-D, any number of devices may access the host computers 30A-B. Likewise, although FIG. 3 depicts only one trail camera 10, the technology of the present invention may be used with any number of trail cameras. In fact, some users may control numerous trail cameras with an account created in accordance with aspects of the present invention described below.

The communications network 34 is preferably the Internet but may be any other communications network such as a local area network, a wide area network, a wireless network, or an intranet. The communication network 34 may also include or be in communication with a wireless phone network such as those operated by AT&T, Verizon, and Sprint and/or networks using CDMA, GSM, or similar wireless technologies. The communications network 34 may also be a combination of several networks. For example, the electronic devices 32A-D may wirelessly communicate with a computer or hub via a Wi-Fi network, which in turn is in communication with one or more of the host computers 30A-B via the Internet or other communication network.

The computer programs of the present invention are stored in or on non-transitory computer-readable medium residing on or accessible by the trail camera 10, the host computers 30A-B, and/or the electronic devices 32A-D. The computer programs comprise ordered listings of executable instructions for implementing logical functions in these devices.

The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any non-transitory means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

In one embodiment, the computer programs of the present invention may partially implement a method of testing the communication coverage of the trail camera 10. With prior art trail cameras with wireless communication capabilities, users must first purchase the trail cameras and then establish wireless phone plans with their chosen carriers as described above. Applicant has discovered that users are often dissatisfied with their purchase experiences because their chosen wireless phone carriers often don't have adequate wireless coverage in the areas in which they wish to use their trail cameras, and they often don't discover this fact until they are setting up the cameras. This forces the users to either re-position their trail cameras in areas with better wireless coverage or to return them and cancel the associated wireless phone plans.

An embodiment of the present invention solves the above-described problem by providing the trail camera 10 with a pre-loaded wireless phone plan. An embodiment of the invention also includes a method of checking the communication coverage of the trail camera 10 before it is purchased.

As part of the method, a manufacturer or seller of the trail camera 10 may set-up a trial or short term wireless phone plan with a wireless phone carrier such as AT&T. The manufacturer may then obtain a coverage map or other information from the carrier that shows the expected signal strength for certain geographic areas. For example, if the trail camera 10 is sold in the U.S., the coverage information may indicate the expected signal strength for all areas within the country. In some embodiments, the coverage information may be provided in a map that is color-coded or otherwise marked to indicate the signal strength of different geographic areas. The coverage map or other coverage information may be stored on one of the server computers 30A-C and/or other computers associated with the website 36 so it can be accessed by the devices 32A-D as described below.

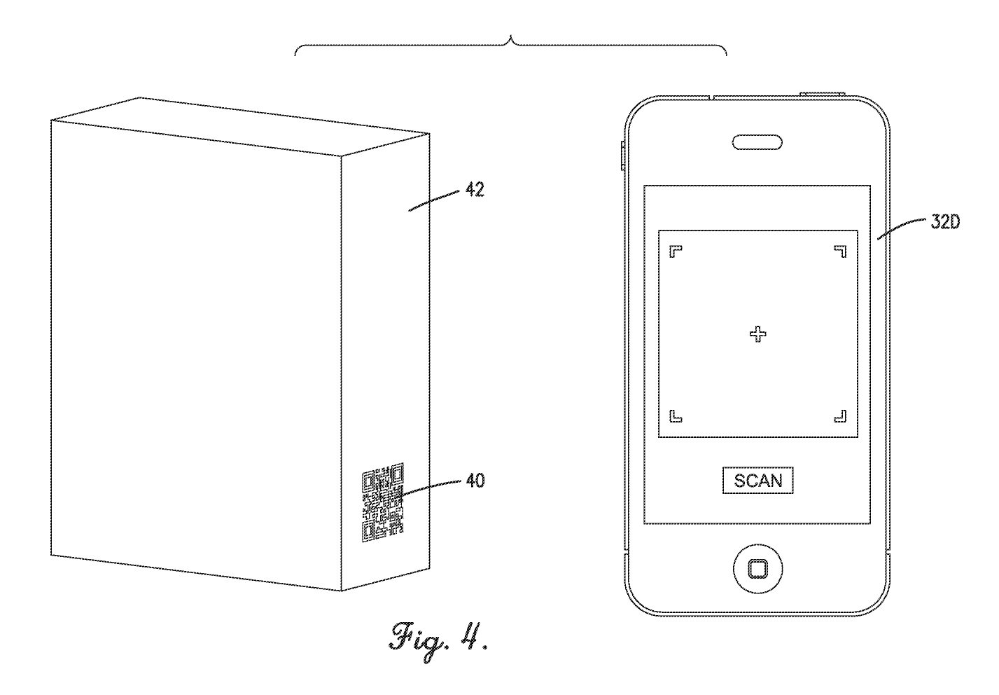

The manufacturer and/or seller of the trail camera 10 may place a scannable code on packaging or a display associated with the trail camera 10. For example, as illustrated in FIG. 4, the scannable code 40 may be placed on packaging 42 of the trail camera or on a display or sign associated with several of the trail cameras. The scannable code 40 may be a Quick Response (QR) code and may contain a computer readable URL that directs a browser on one of the computers 32A-D or other device to the website 36 after scanning or otherwise reading the code 40. A sign or other display item in the vicinity of the trail camera 10 at the place of purchase may instruct the customer to scan the scannable code before the customer purchases the trail camera 10.

After the scannable code 40 is read and the URL in the code directs the browser on the computer 32A-D to the website 36, the website prompts the user to enter information that specifies an area where the trail camera will be used. For example, as shown in FIG. 5, the website 36 may prompt the user to enter a zip code for the area where the trail camera will be mounted. Alternatively, the user may be prompted for an exact address, GPS coordinates, or anything else that identifies the desired mounting location of the trail camera 10.

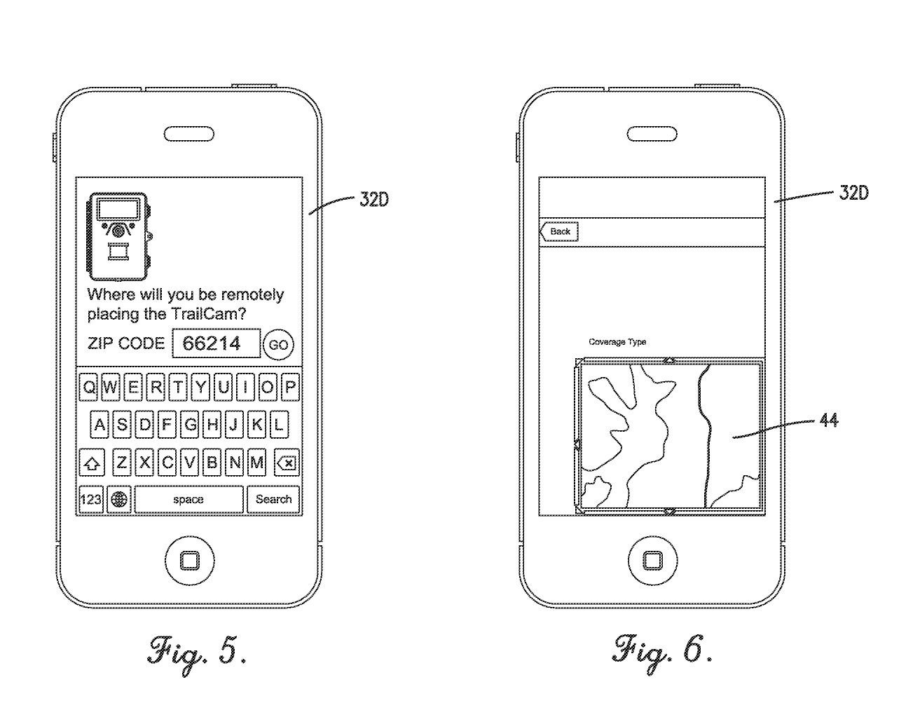

One of the computers 30A-B or another computer then compares the entered zip code or other location information to the coverage information provided by the wireless carrier and provides coverage information to the mobile phone 32D. As shown in FIG. 6, the coverage information may be in the form of a map 44 that shows the carrier's expected signal strength in areas encompassed by the zip code or other location information. This enables the user to determine if the trail camera will have communication coverage in his or her desired mounting location before the customer purchases the trail camera.

Once the user has verified the coverage of a trail camera and purchased it, the user is prompted to set-up an account for the trail camera (and other trail cameras if the user owns several). If the user already has an account, he or she may be prompted to access the existing account to add the purchased trail camera to the account.

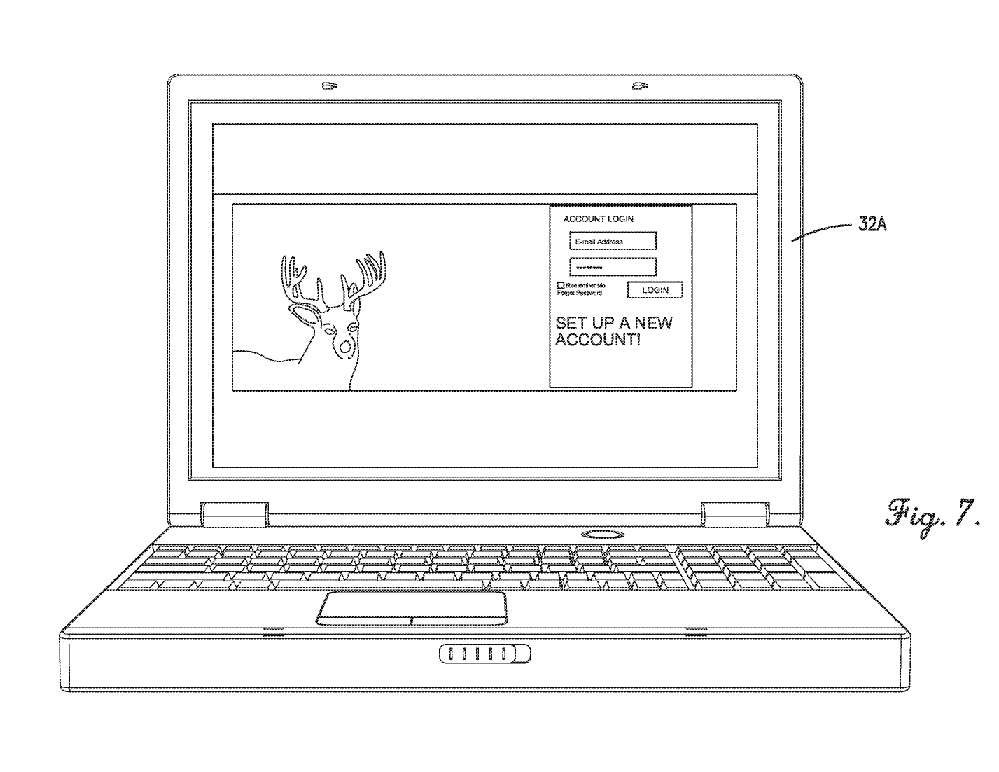

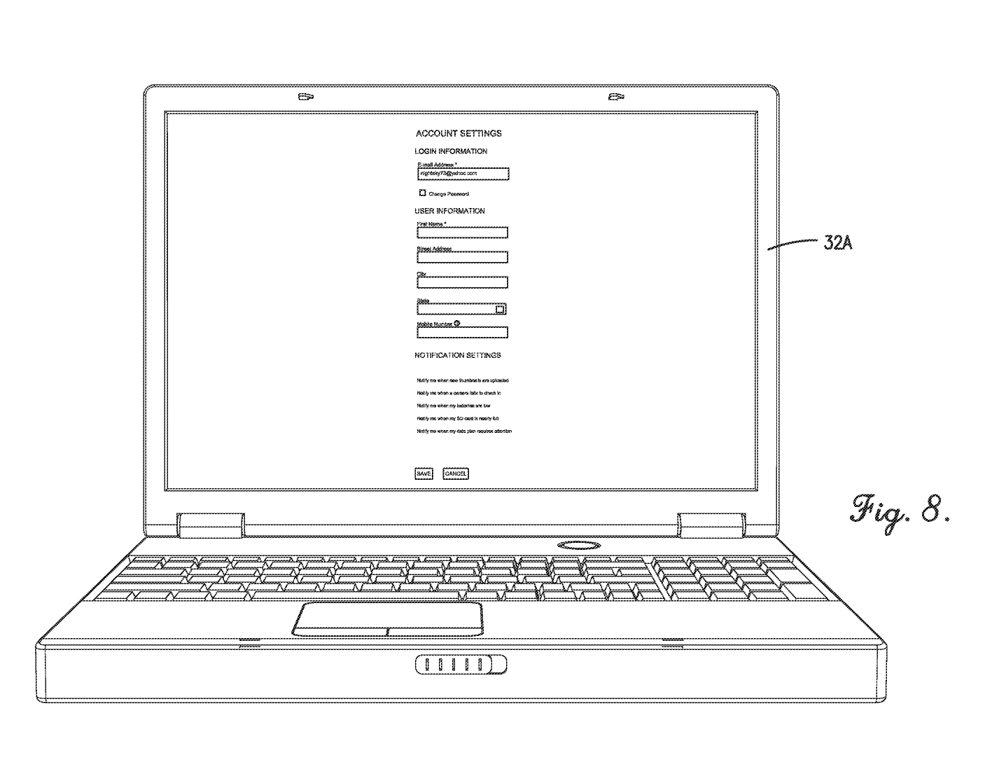

FIGS. 7-10 illustrate screen displays that may be presented on one of the computing devices 32A to assist the user while accessing an existing account or setting up a new account. An initial screen shown in FIG. 7 prompts the user to either log-in to an existing account or to create a new account is shown in FIG. 7. FIG. 8 shows a screen that may be displayed when the user elects to set up a new account. The screen may prompt the user to enter an email address, mobile phone number, and other contact information and also prompts the user to select a number of notification settings.

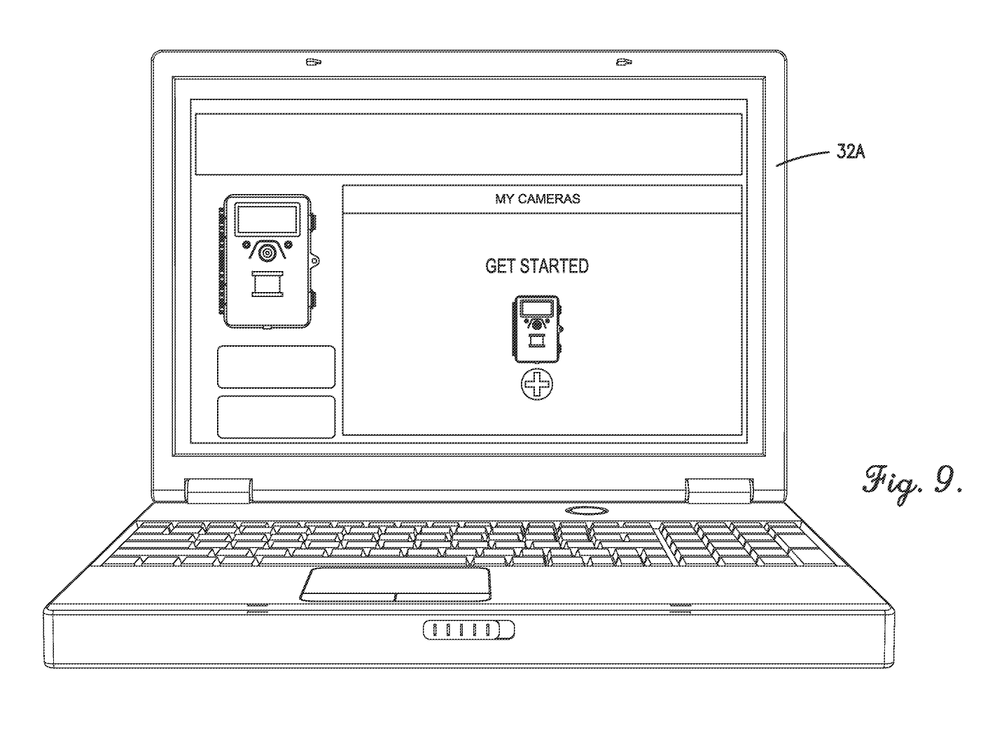

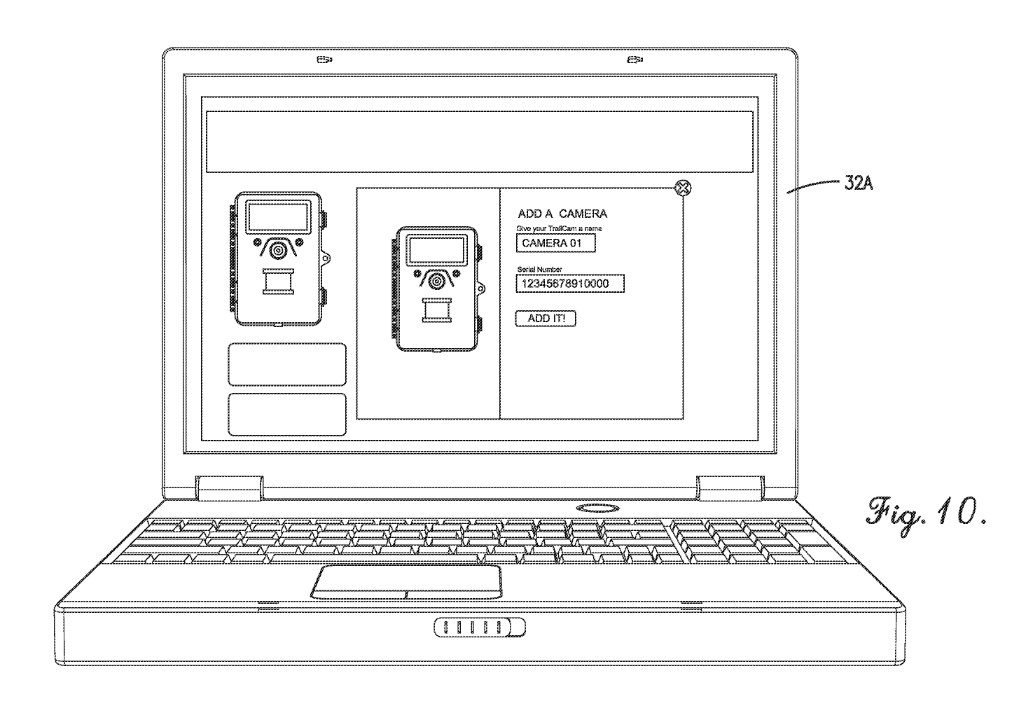

FIGS. 9 and 10 show screens that prompt the user to add a purchased trail camera to the user account. For example, the screen of FIG. 10 prompts the user to enter a name and a serial number or other identifier for the camera and to then select an Add It button or other user interface element to add the camera to the user's account.

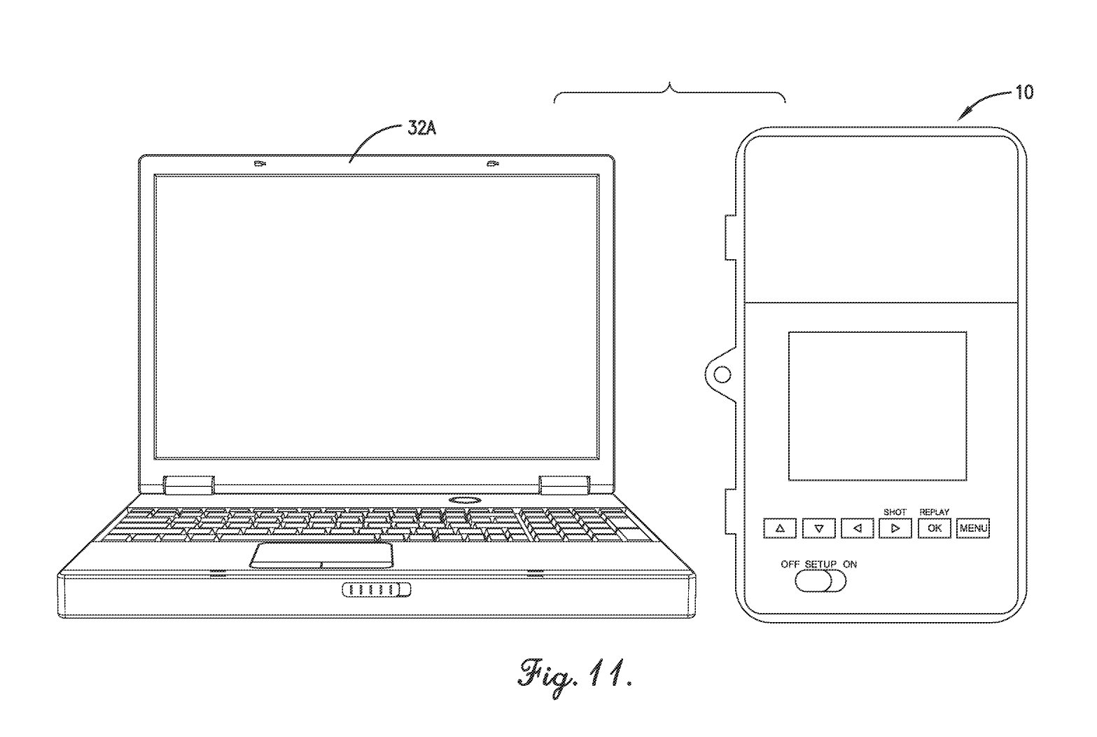

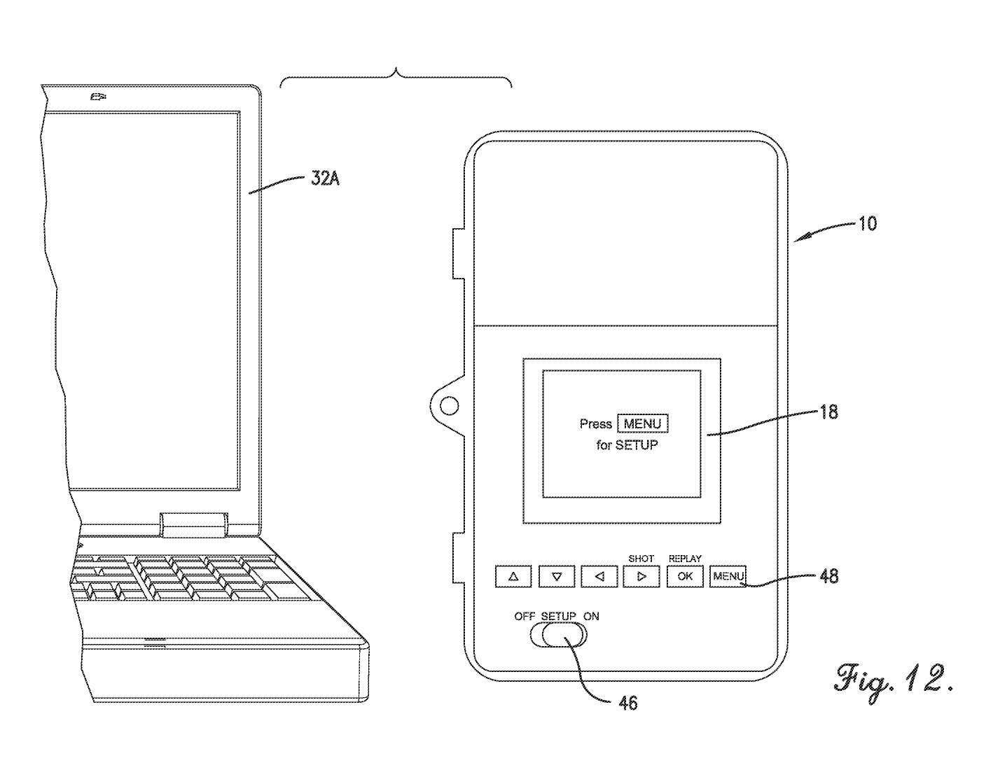

FIGS. 11-14 illustrate screen displays that may be presented on the trail camera 10 to assist the user in setting up or otherwise configuring the trail camera 10 after it has been added to the user account as described above. The user first moves a switch 46 on the trail camera to a Setup position as shown in FIG. 12. The display 18 on the trail camera 10 then prompts the user to press a Menu button 48 to begin setting up the camera.

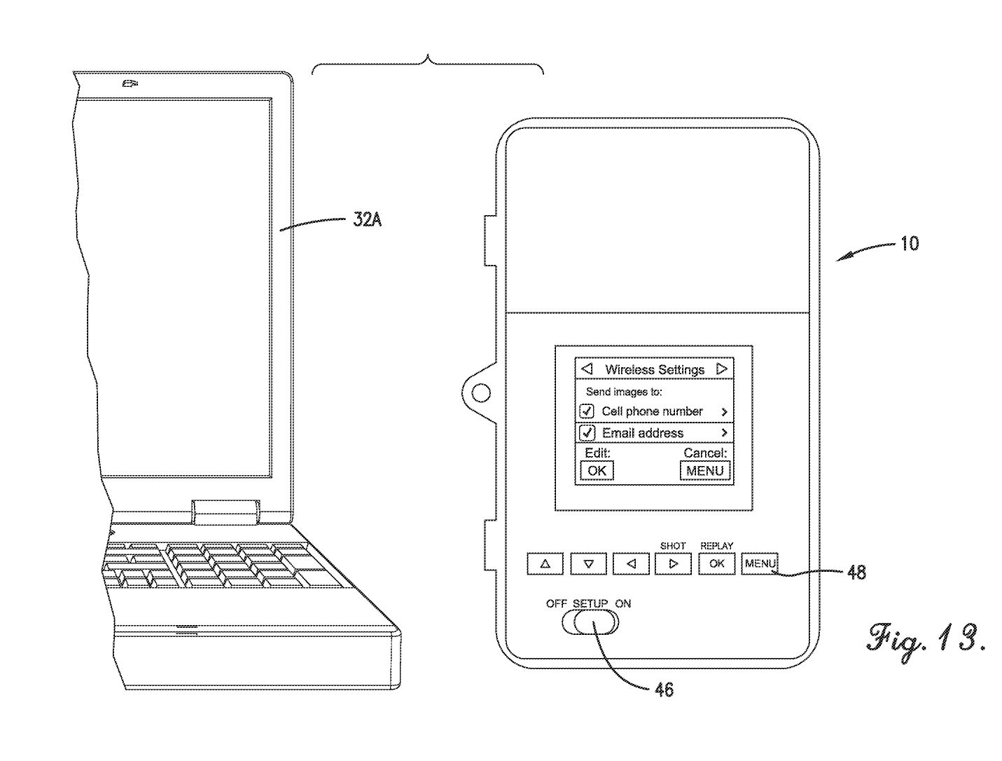

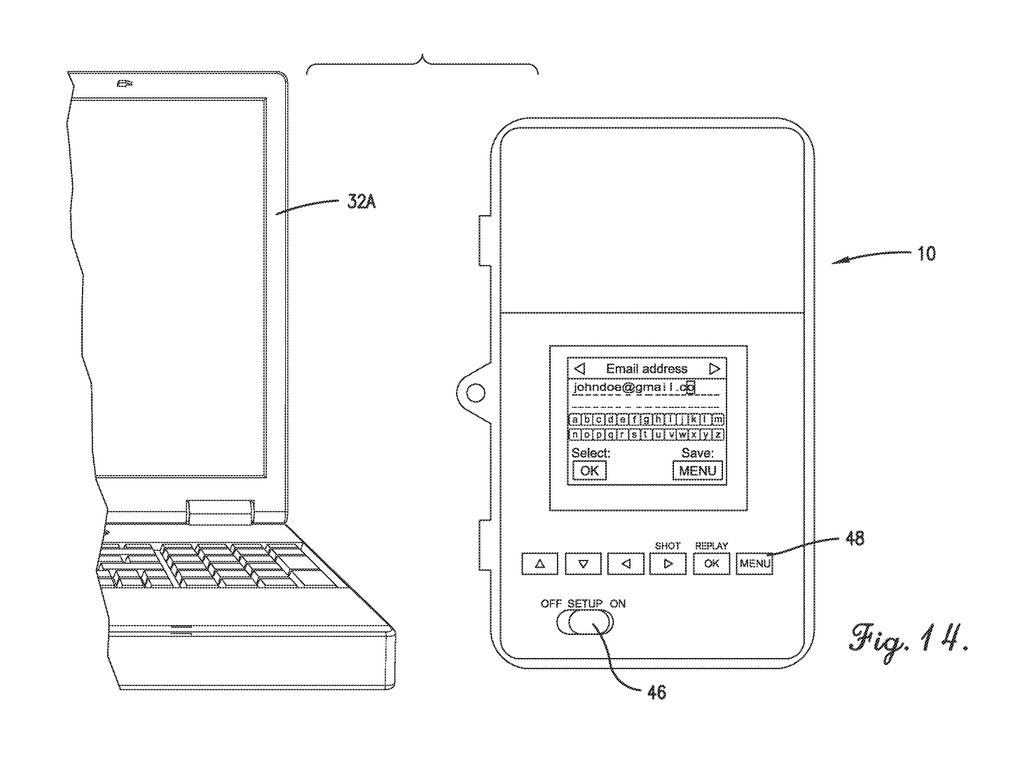

FIG. 13 shows a screen that assists the user in selecting wireless settings for the trail camera 10. As shown, the screen permits the user to instruct the trail camera 10 to send captured images to a cell phone number and/or an email address. FIG. 14 shows a screen that prompts the user to enter the email address to which images should be sent. The same screen or a similar screen may prompt the user to enter a mobile phone number to which images should be sent. All settings and other configuration information for the trail camera are stored locally on the trail camera and transmitted to the user's account maintained by the computers 30A-C.

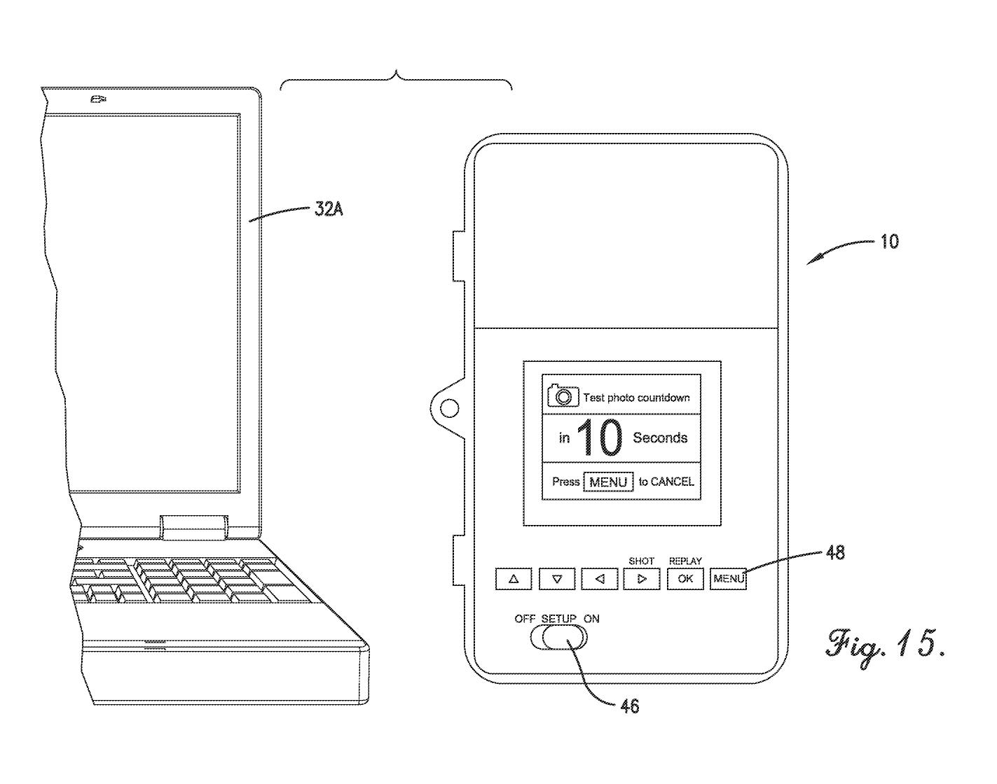

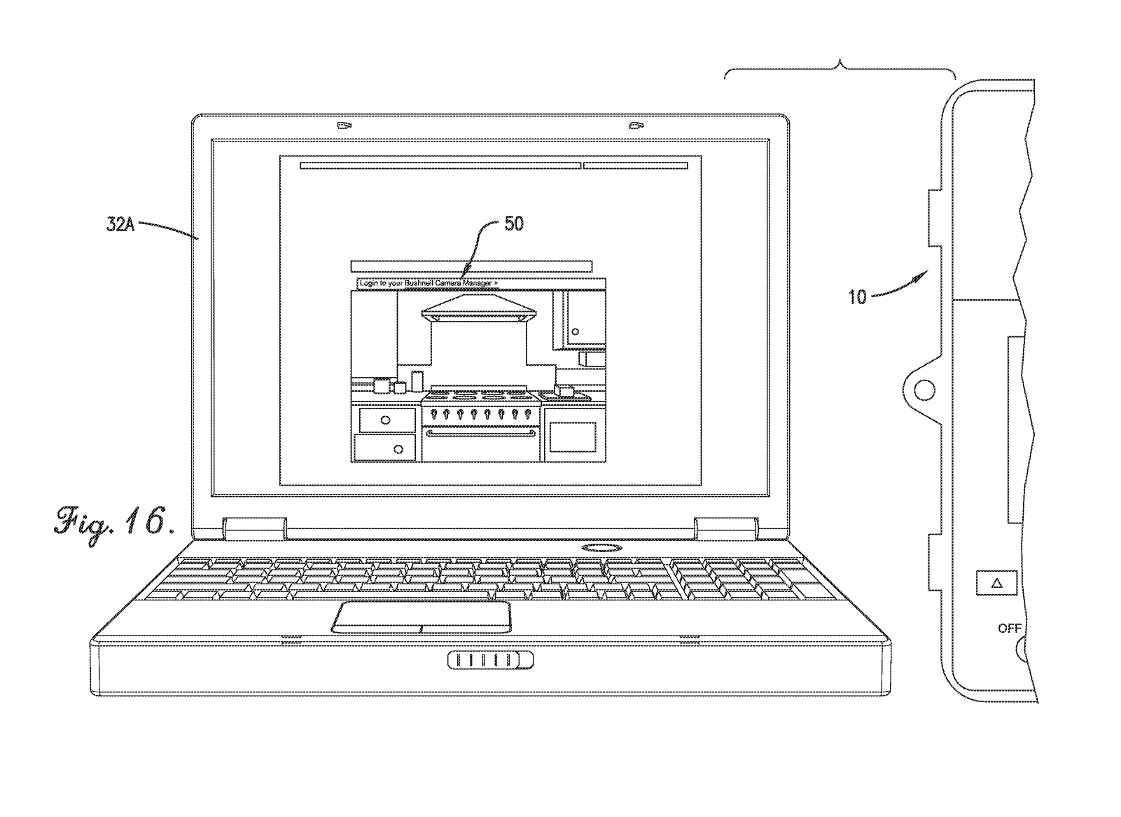

FIGS. 15 and 16 depict a process in which the controller 20 of the trail camera 10 prompts the camera 12 to automatically capture a test image. After the camera is set-up as described above, a countdown is presented on the trail camera's display as shown in FIG. 15. The countdown informs the user that a test image will be captured in a pre-determined amount of time. This allows the user to aim the trail camera at a desired object before the test image is captured. At the end of the countdown, the camera 12 automatically captures a test image. The test image is then sent to one of the computers 30A-C and/or directly to the user's mobile phone or email address. For example, the test image 52 may be sent to the user's designated email account and opened with the computer 32A as shown in FIG. 16. This allows the user to verify the trail camera is working and was set-up properly.

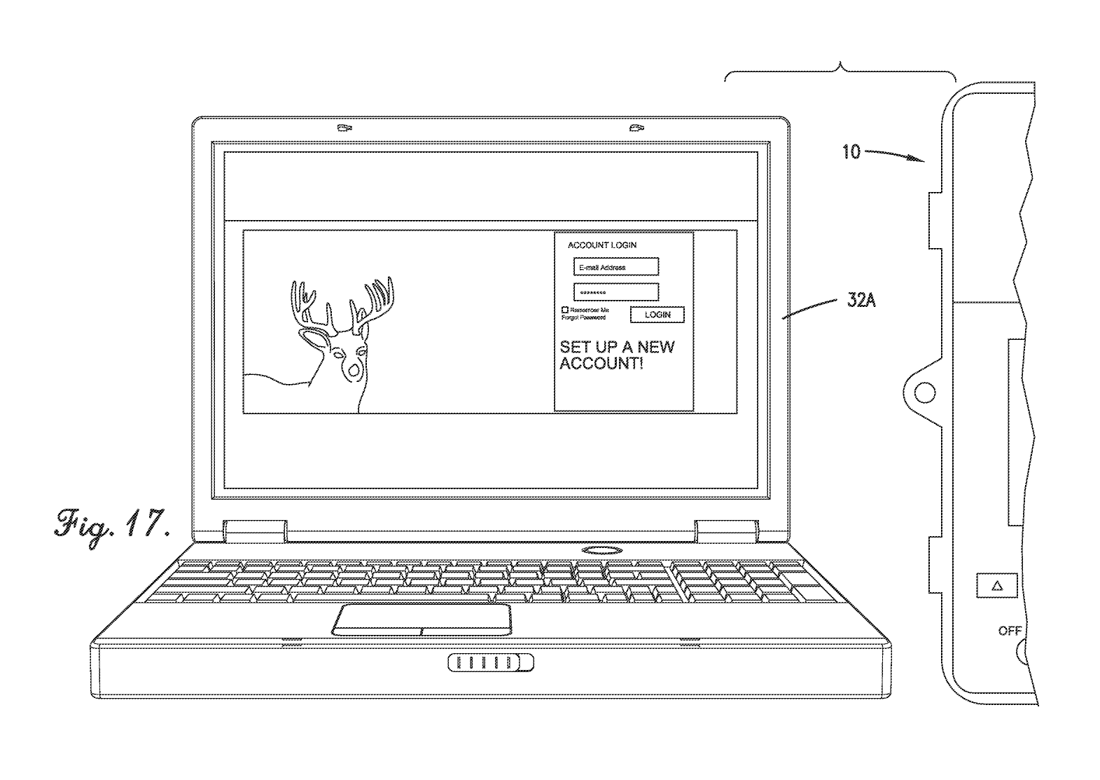

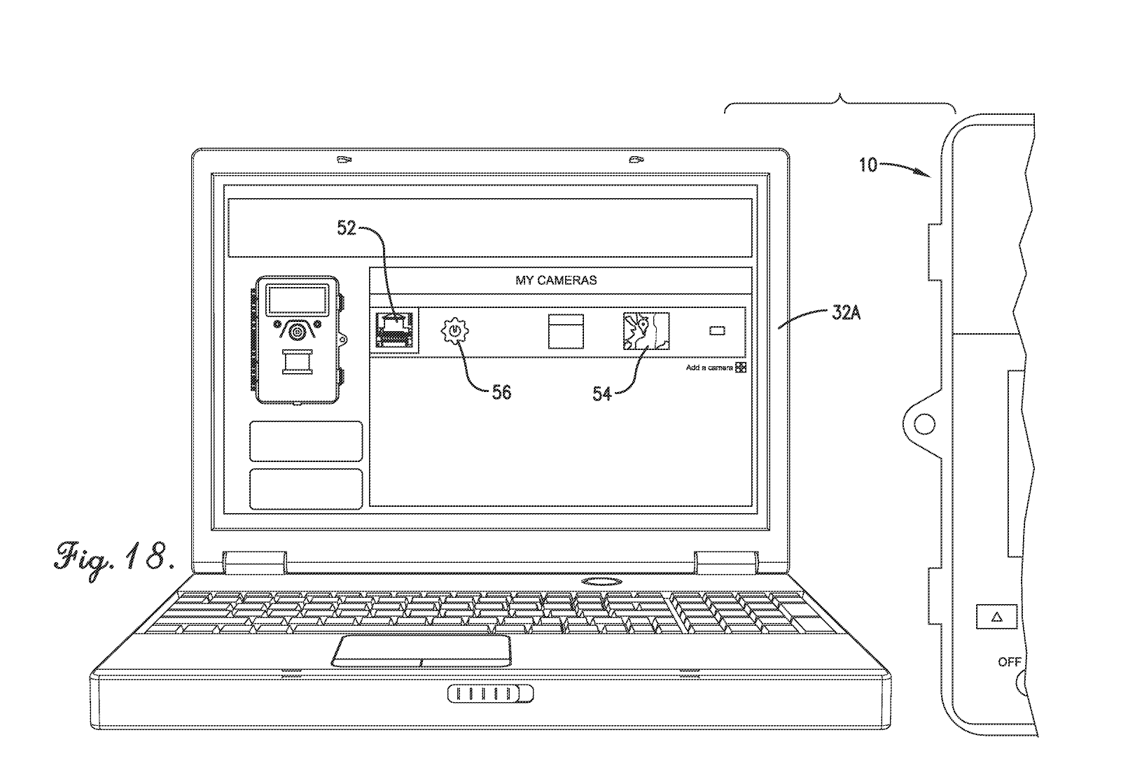

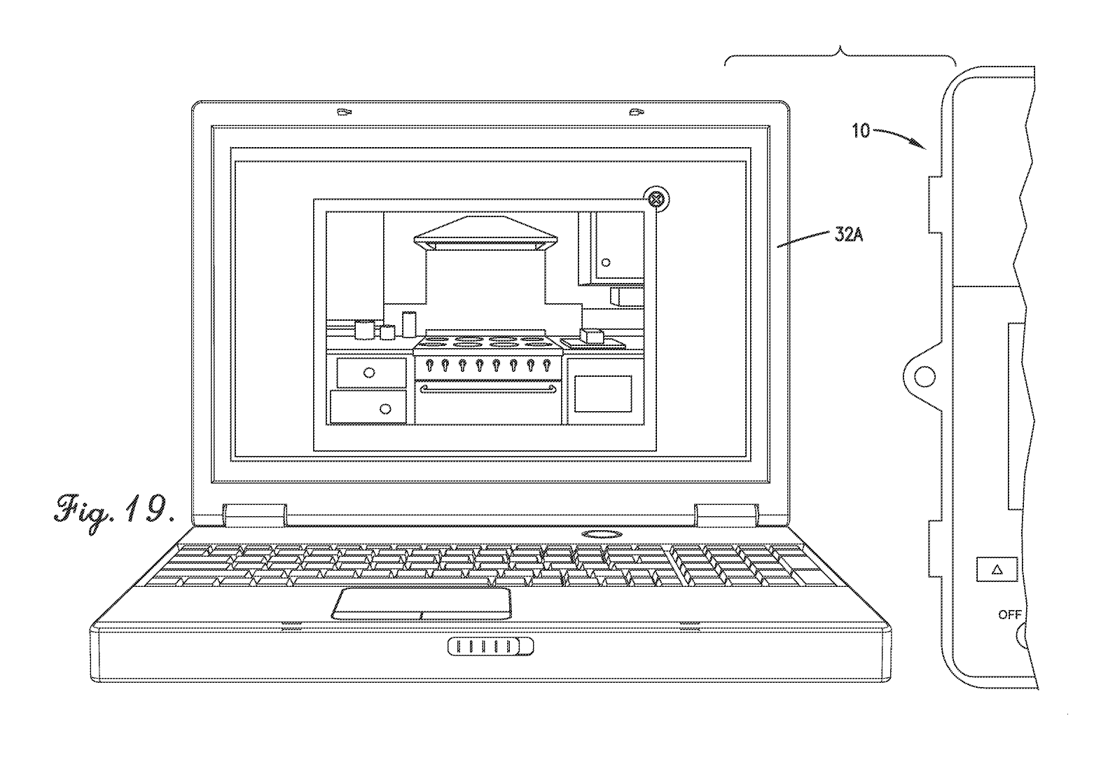

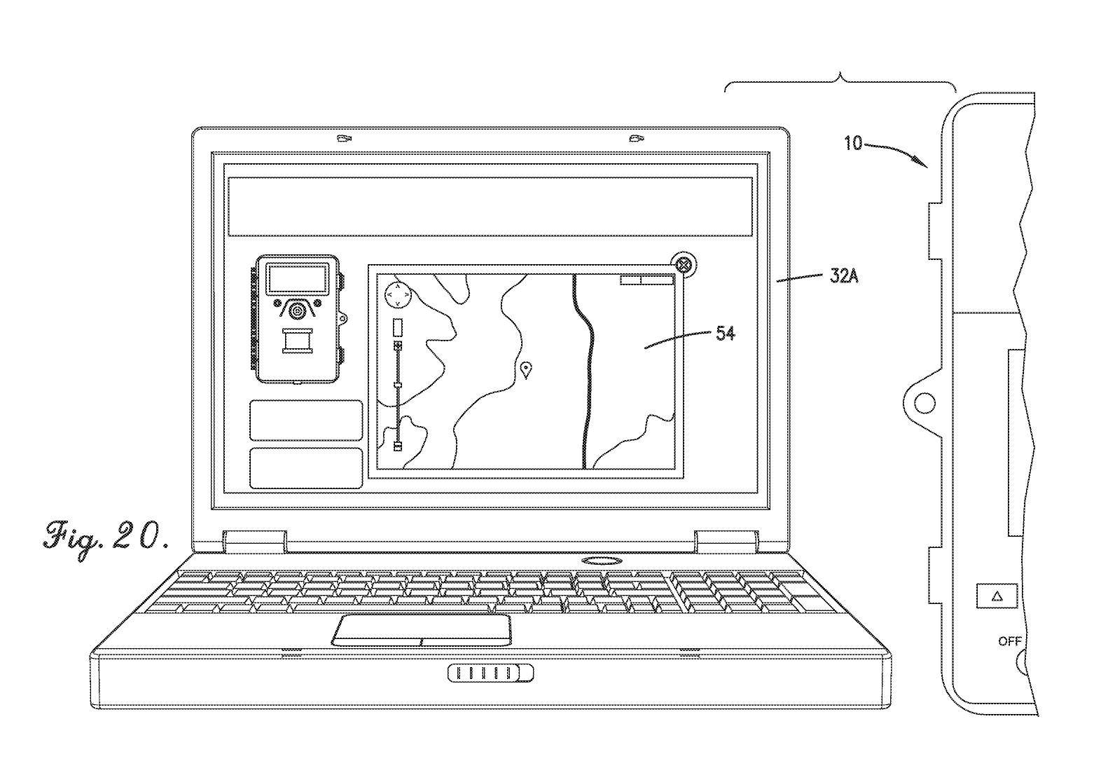

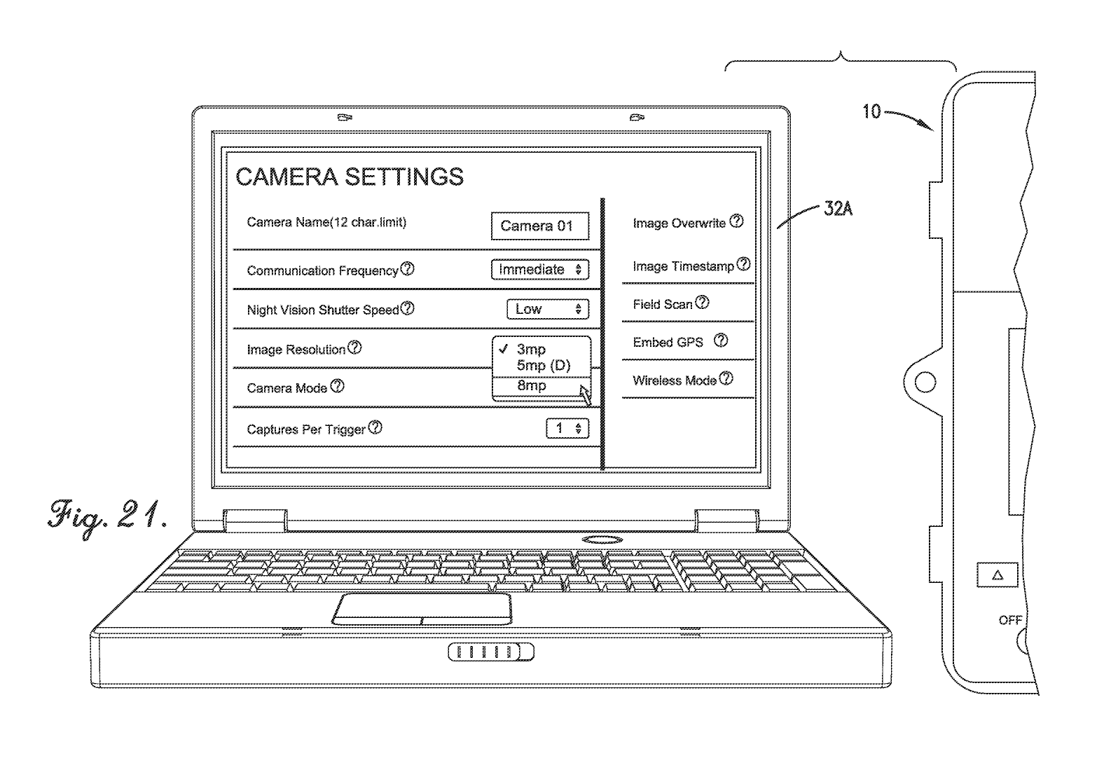

The test image may be accompanied by a link 50 that directs the browser on the computer 32A to the log-in screen of the website 36 as shown in FIGS. 16 and 17. The user may then enter information to log into his or her account. Once logged in, the user may view thumbnail versions of all images captured by the trail camera including the test image 52 as shown in FIG. 18. The user may click-on or otherwise select the thumbnail image 52 to enlarge it as shown in FIG. 19. The account may also display a map 54 showing the geographic location of the camera as shown in FIG. 18. The user may click-on or otherwise select the map to enlarge it as shown in FIG. 20.

The account may also display a Settings icon 56 as shown in FIG. 18. The user may click-on or otherwise select the icon 56 to display a number of camera settings as shown in FIG. 21.

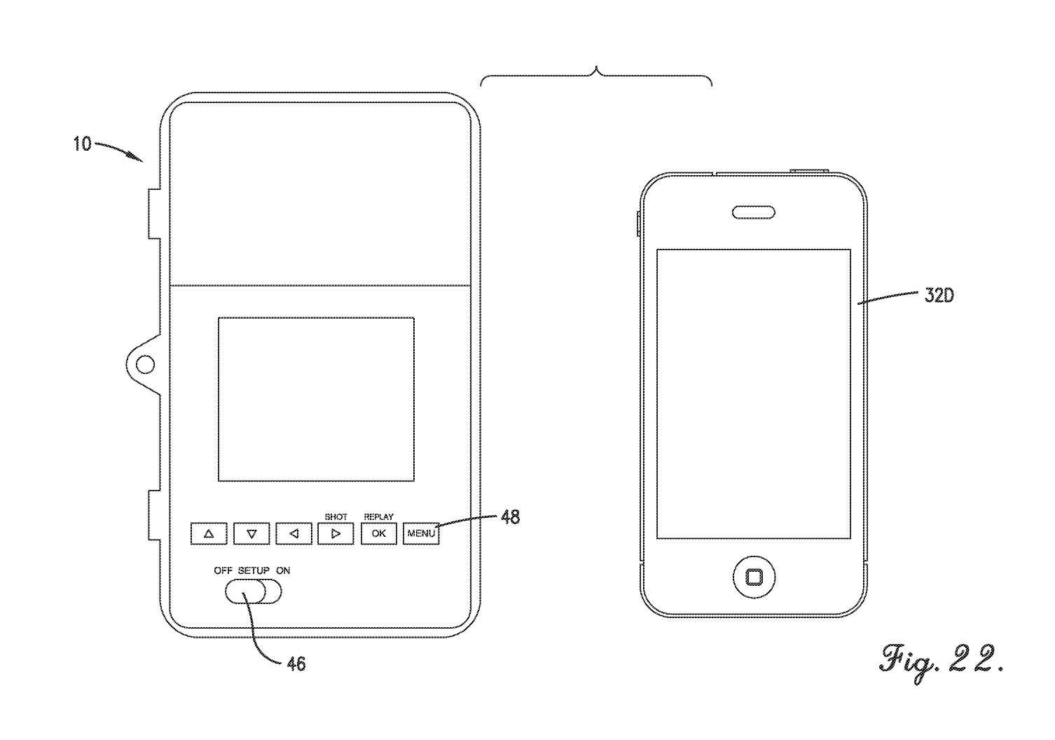

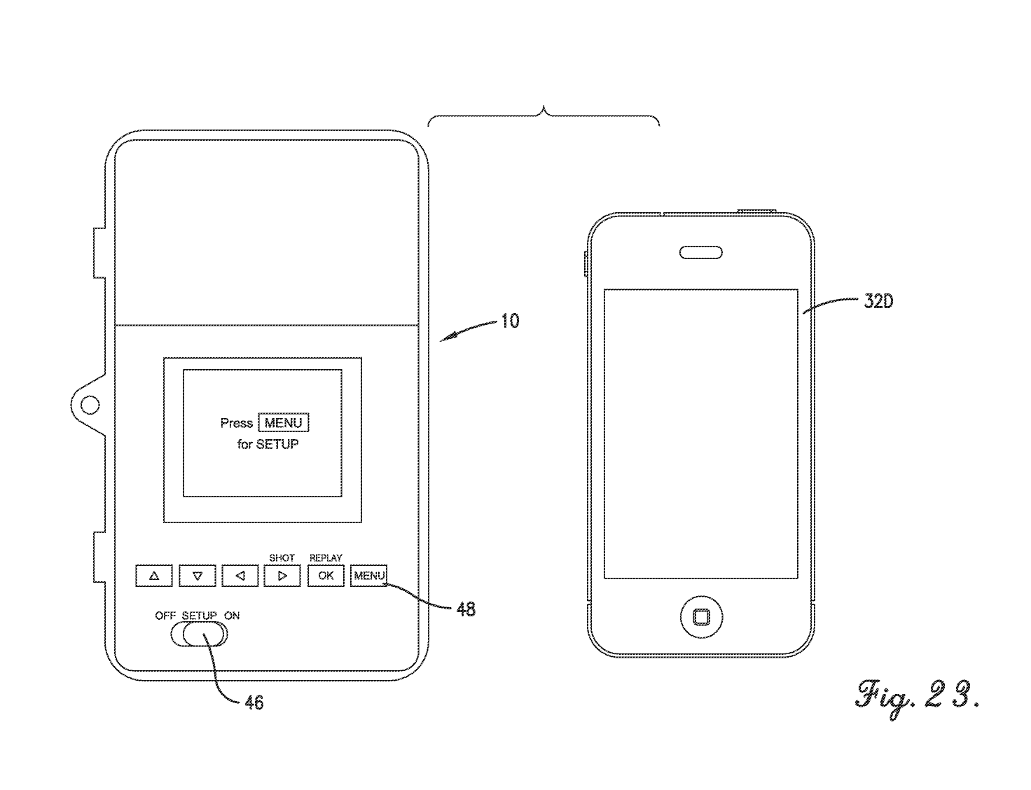

The trail camera 10 may also be configured in the field with the assistance of the mobile phone 32D. FIGS. 22-28 illustrate screen displays that may be presented on the trail camera's display when setting up the camera in this mater.

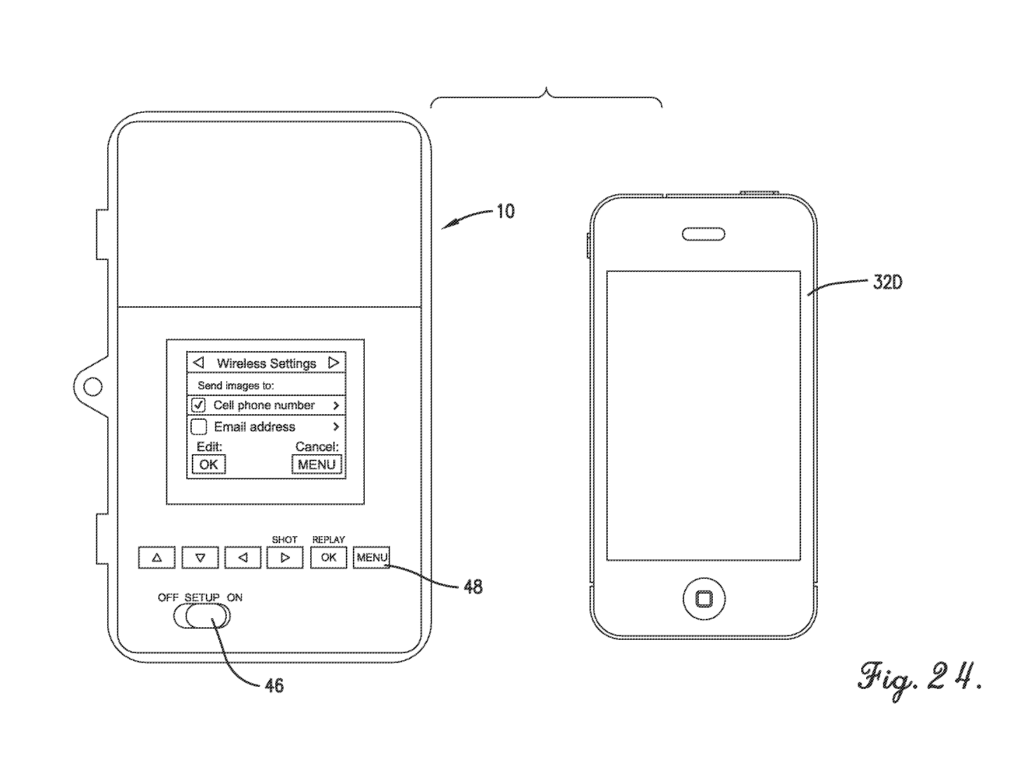

As shown in FIG. 22, the user first moves the switch 46 on the trail camera to the Setup position. The display 18 on the trail camera then prompts the user to press a Menu button 48 to begin setting up the camera as shown in FIG. 23.

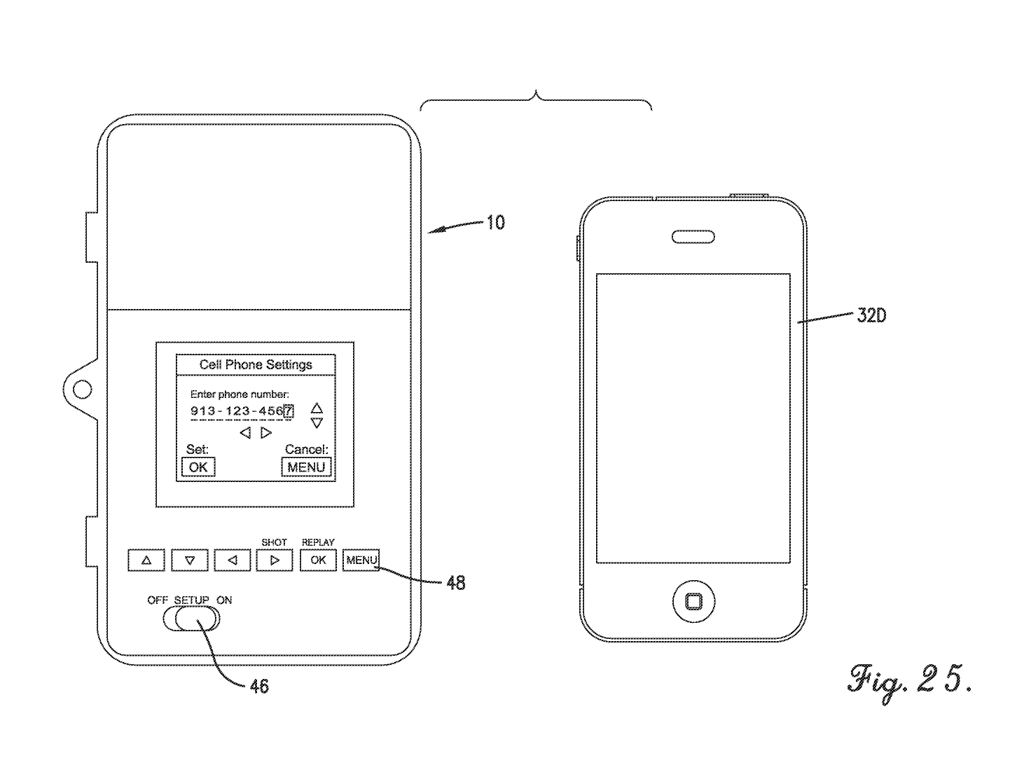

FIG. 24 shows a screen that assists the user in selecting wireless settings for the trail camera. As shown, the screen permits the user to instruct the trail camera to send captured images to a cell phone number and/or an email address. For example, FIG. 25 shows a screen that prompts the user to enter a mobile phone number to which images should be sent.

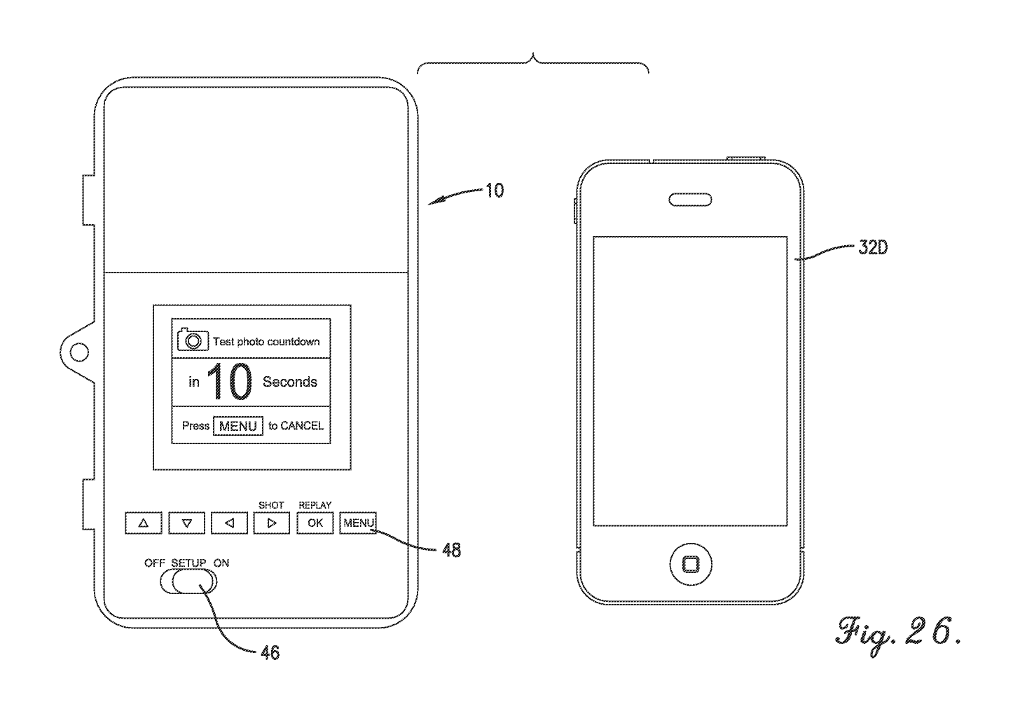

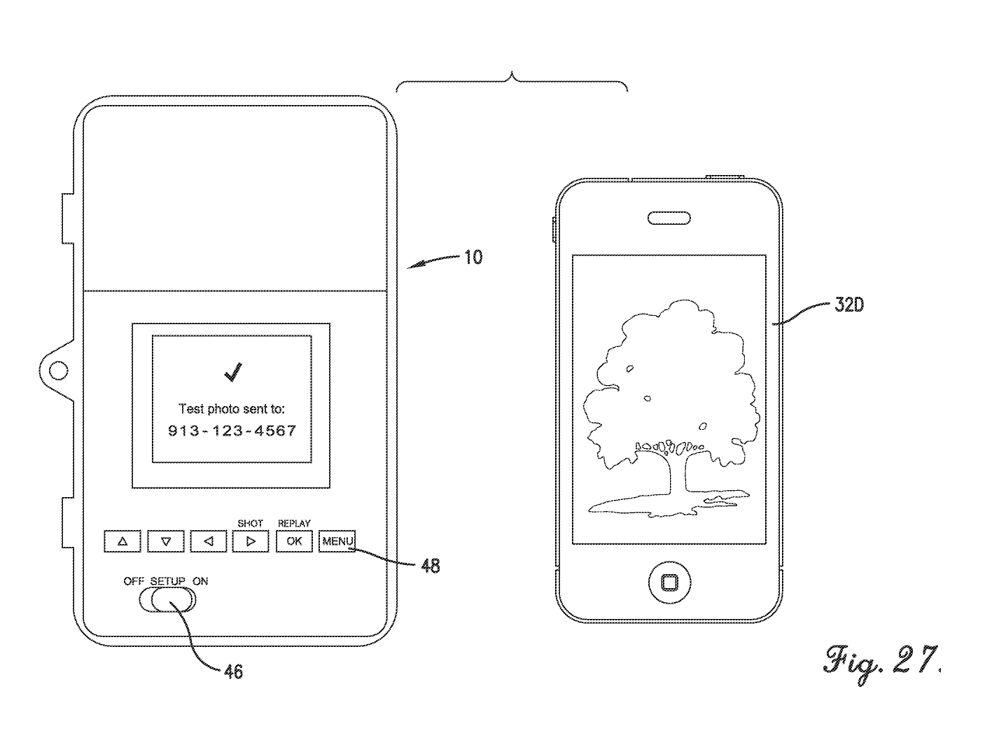

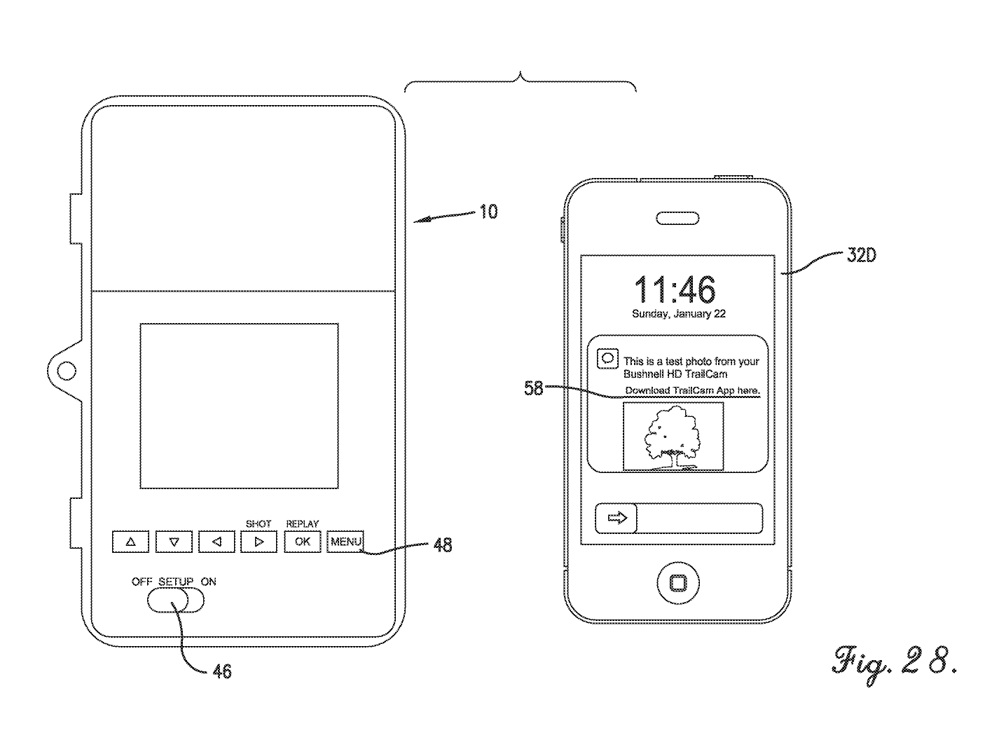

FIGS. 26 and 27 depict the process in which the controller 20 of the trail camera 10 prompts the camera 12 to automatically capture a test image. After the trail camera is set-up as described above, a countdown is presented on the trail camera's display as shown in FIG. 26 and is described above. At the end of the countdown, the camera automatically captures a test image and sends it to the user's mobile phone 32D as shown in FIG. 23. The test image may be accompanied by a link 58 that allows the mobile phone to download a mobile phone application that enables the user to configure and otherwise interact with the trail camera 10 as shown in FIG. 28.

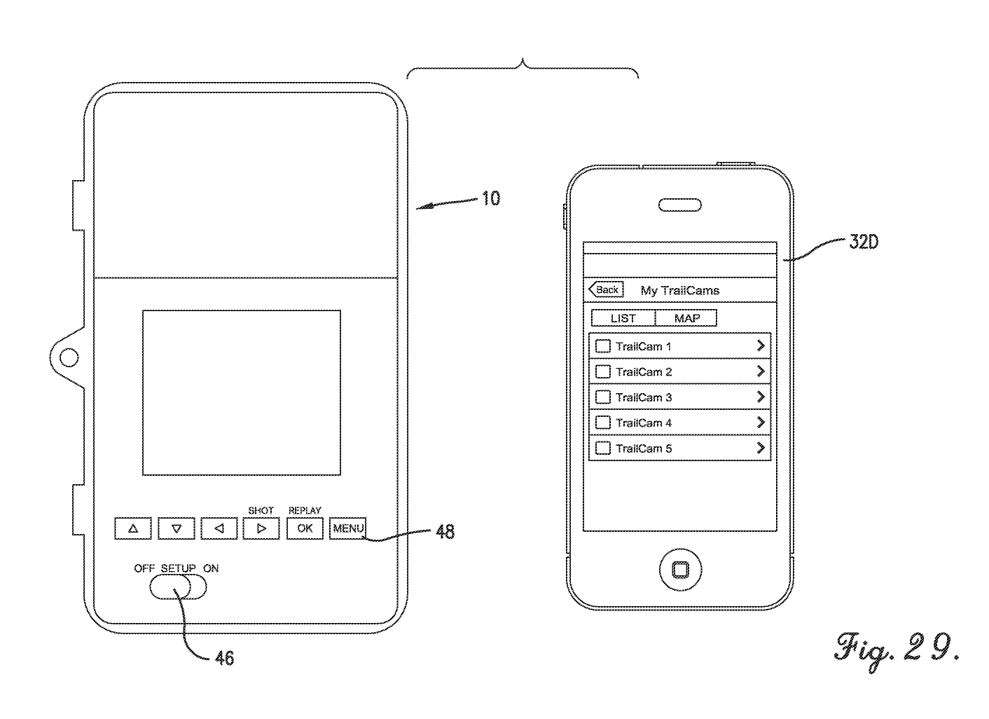

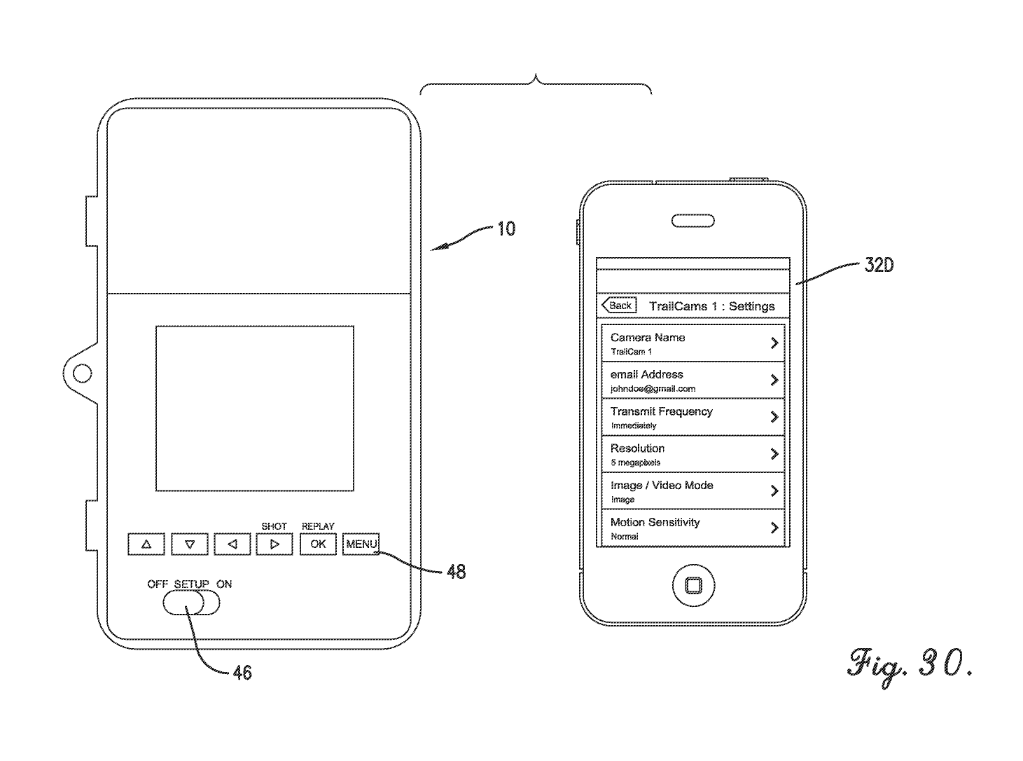

In one embodiment, the mobile phone application presents a screen display that permits the user to view information for all the user's trail cameras in either a List View or a Map View as shown in FIG. 29. If the user selects the List View, all the user's cameras are presented in a list as shown. The user may click-on or otherwise select one of the cameras in the list to reveal the settings for the camera as shown in FIG. 30. The user may then click-on or select any of the settings to make changes. For example, the user may alter the resolution of the camera as shown in FIG. 31 or change the image transmit frequency as shown in FIG. 32.

If the user selects the Map View on the screen in FIG. 29, the locations of all the cameras are indicated on a map as shown in FIG. 33. The user may click-on or otherwise select one of the cameras on the map to reveal the settings for the camera in the same manner as described above.

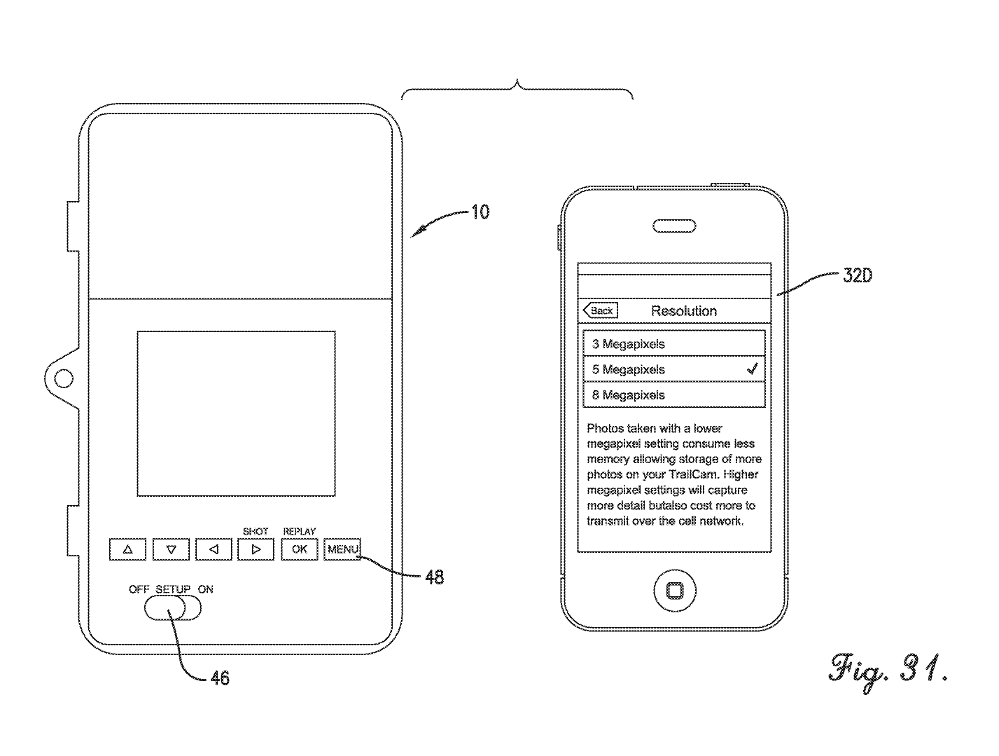

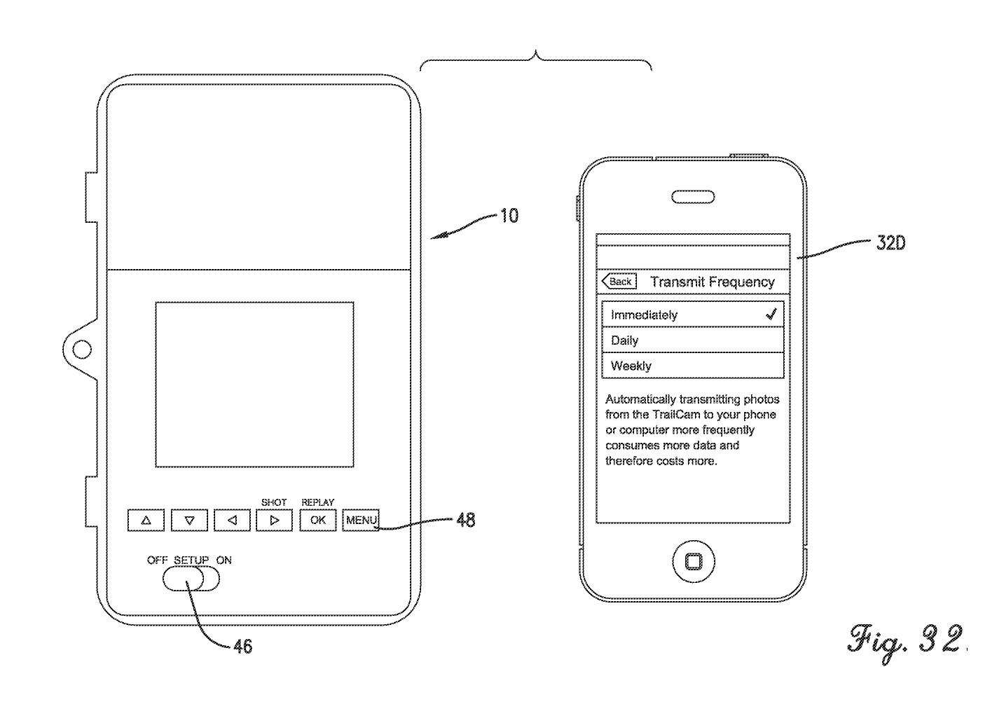

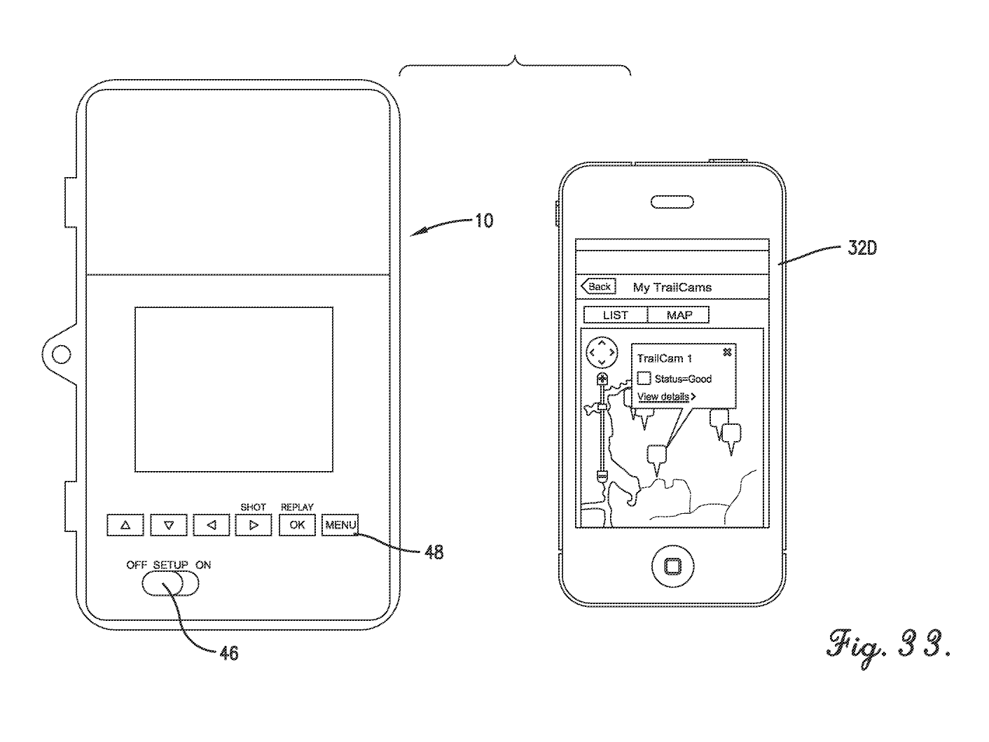

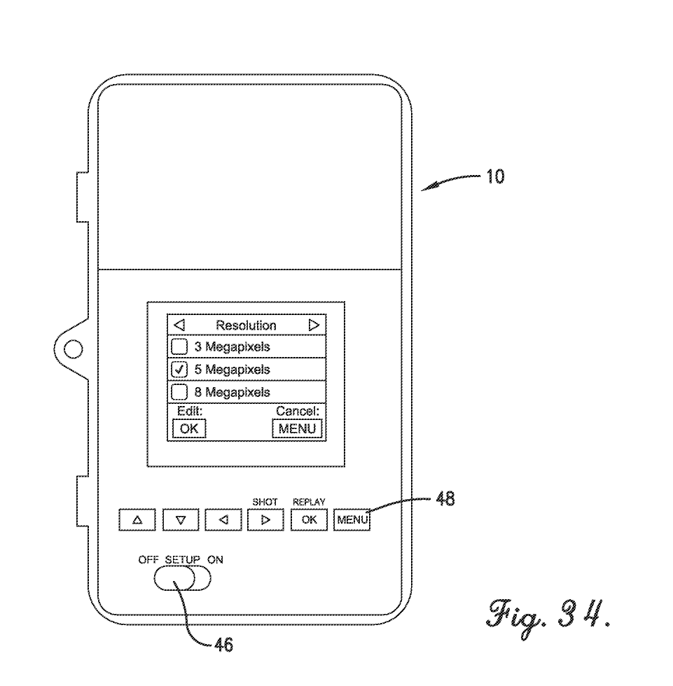

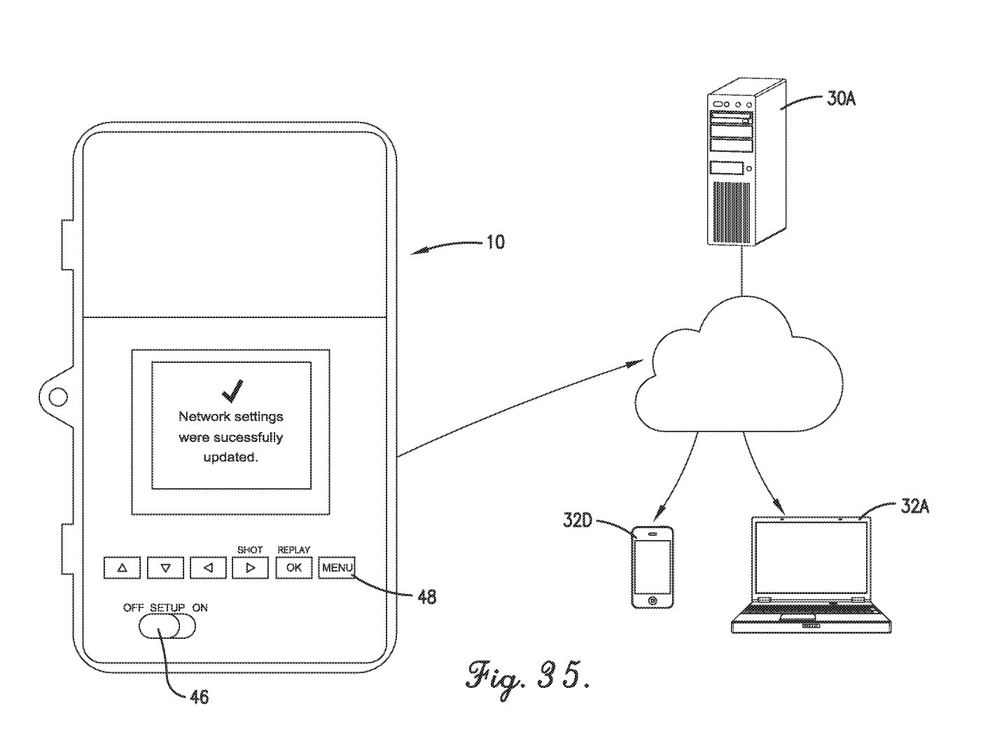

The user may also change the settings of the camera in the field on the camera itself as shown in FIG. 34. Whenever the trail camera's settings are changed locally at the camera itself, the revised settings are sent to or made available to the one of the server computers 30A-C and the mobile phone application as shown in FIG. 35. Likewise, whenever the trail camera's settings are changed via the mobile phone application or the computer 32A, the revised settings are sent to and stored on the trail camera 10 and one of the server computers 30. This two-way command and control functionality allows a user to locally set-up and control the trail camera from the trail camera's user interface or remotely set-up and control the trail camera from a remote computer or phone. In all cases, the controller 20 at the trail camera receives and stores instructions needed for setting up the camera and the computers associated with the website 36 receive and store configuration information needed for handling images transmitted from the camera.

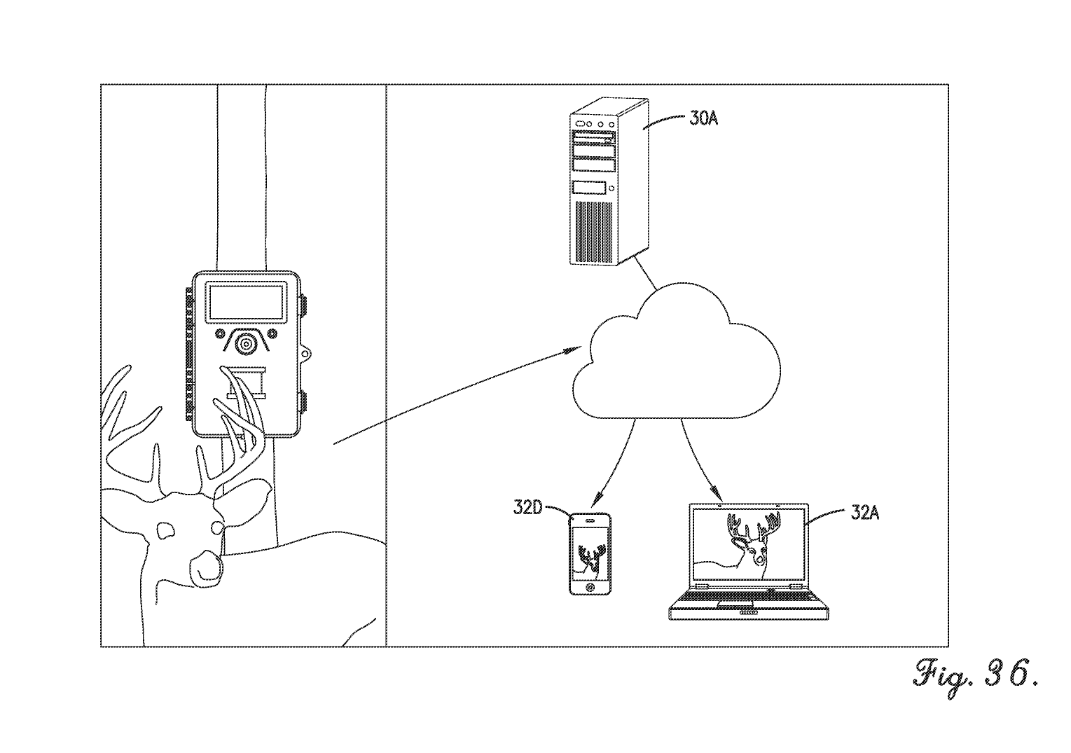

FIG. 36 shows the trail camera 10 capturing an image of a deer as it walks by the camera and triggers its sensors. The captured image is transmitted to the computers 30 in accordance with the transmission frequency setting of the camera. The image is then sent to the user's mobile phone and/or email address as indicated in the user's configuration settings.

Although the invention has been described with reference to the preferred embodiment illustrated in the attached drawing figures, it is noted that equivalents may be employed and substitutions made herein without departing from the scope of the invention as recited in the claims. For example, although the technology of the present invention is particularly useful for trail cameras, it may also be employed in other camera systems such as surveillance cameras.

Having thus described the preferred embodiment of the invention, what is claimed as new and desired to be protected by Letters Patent includes the following:

1. A camera system comprising:
a camera operable for capturing images;
a communication device for transmitting the images to a remote computer; and
a controller for prompting the camera to automatically capture a test image a pre-determined number of seconds after the trail camera is set-up, the controller subsequently prompting the communication device to automatically send the test image to the remote computer.

2. The camera system as set forth in claim 1, wherein the communication device is a cellular transceiver.

3. The camera system as set forth in claim 1, further comprising a display controlled by the controller, wherein the controller displays a countdown of the pre-determined number of seconds before the camera captures the test image.

4. The camera system as set forth in claim 1, further comprising a user interface for permitting a user to control and interact with the controller.

5. The camera system as set forth in claim 4, the user interface and the controller permitting the user to enter a mobile phone number on or an email address to which the test image should be sent.

6. The camera system as set forth in claim 1, further comprising a sensor coupled with the controller and operable to sense motion or heat near the trail camera for triggering the camera to capture an image.

7. A camera system comprising:
a) a trail camera comprising:
a camera operable for capturing images;
a communication device for wirelessly transmitting the images;
a controller for locally controlling the camera and the communication device; and
b) a computer remote from the camera, the computer comprising:
a communication device for receiving the images from the trail camera;
computer programs stored on non-transitory computer readable memory for implementing a website, the website operable to receive configuration information for the trail camera from another computer or mobile phone or from the trail camera itself.

8. The camera system as set forth in claim 7, wherein the controller of the trail camera prompts the camera to automatically capture a test image a pre-determined number of seconds after the trail camera is set-up and subsequently prompts the communication device to automatically send the test image to the remote server.

9. The camera system as set forth in claim 7, wherein the communication device of the trail camera is a cellular transceiver.

10. The camera system as set forth in claim 8, the trail camera further comprising a display controlled by the controller, wherein the controller displays a countdown of the pre-determined number of seconds before the camera captures the test image.

11. The camera system as set forth in claim 8, the trail camera further comprising a user interface for permitting a user to control and interact with the controller.

12. The camera system as set forth in claim 11, the user interface and the controller permitting the user to enter a mobile phone number on or an email address to which the test image should be sent.

13. The camera system as set forth in claim 7, the configuration information including account log-in information, camera settings, and notification settings.

14. The camera system as set forth in claim 7, the trail camera further comprising a sensor coupled with the controller and operable to sense motion or heat near the trail camera for triggering the camera to capture an image.

15. A method of checking communication coverage of trail cameras equipped with wireless communication devices, the method comprising:
placing a scannable code on packaging or a display associated with a trail camera offered for sale;
instructing a customer to scan the scannable code with a mobile communication device before the customer purchases the trail camera;
prompting the customer to enter information into the mobile communication device that specifies a geographic area where the trail camera will be used; and
providing to the mobile communication device coverage information for the geographic area so the customer can determine if the trail camera will have communication coverage in the geographic area before the customer purchases the trail camera.

16. The method of claim 15, wherein the scannable code is s QR code.

17. The method of claim 15, wherein the coverage information includes a coverage map.

18. The method of claim 15, wherein the information for the geographic area comprises a zip code.

19. The method of claim 15, wherein the scannable code includes a link to a website for implementing the prompting step and the providing step.
